(19) United States
(12) Patent Application Publication
(10) Pub. No.: US 2023/0135634 A1
(43) Pub. Date: May 4, 2023

(54) CUSTOMIZING APPLICATION EXTENSIONS TO ENABLE USE OF MICROAPPS

(71) Applicant: Citrix Systems, Inc., Fort Lauderdale, FL (US)

(72) Inventor: Manbinder Pal Singh, Coral Springs, FL (US)

(21) Appl. No.: 17/516,868

(22) Filed: Nov. 2, 2021

(51) Int. Cl. G06F 8/36

(52) U.S. Cl. CPC G06F 8/36

(57) ABSTRACT

One disclosed method involves determining that configuration data is associated with a first user, and causing, based at least in part on the configuration data being associated with the first user, extension code for a first application to be customized for the first user based at least in part on the configuration data, wherein the extension code is configured to enable the first application to present a user interface for a second application in response to a user input to the first application.

### BACKGROUND

Various systems have been developed that allow client devices to access applications and/or data files over a network. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method comprises determining that configuration data is associated with a first user; and causing, based at least in part on the configuration data being associated with the first user, extension code for a first application to be customized for the first user based at least in part on the configuration data, wherein the extension code is configured to enable the first application to present a user interface for a second application in response to a user input to the first application.

In some embodiments, a system comprises at least one processor, and at least one computer-readable medium encoded with instructions which, when executed by the at least one processor, cause the system to determine that configuration data is associated with a first user, and to cause, based at least in part on the configuration data being associated with the first user, extension code for a first application to be customized for the first user based at least in part on the configuration data, wherein the extension code is configured to enable the first application to present a user interface for a second application in response to a user input to the first application.

In some embodiments, at least one non-transitory computer-readable medium is encoded with instructions which, when executed by at least one processor of a system, cause the system to determine that configuration data is associated with a first user, and to cause, based at least in part on the configuration data being associated with the first user, extension code for a first application to be customized for the first user based at least in part on the configuration data, wherein the extension code is configured to enable the first application to present a user interface for a second application in response to a user input to the first application.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example system for customizing an application extension to enable use of microapps in accordance with some aspects of the present disclosure;

FIG. 1B shows a first example display screen of the client device shown in FIG. 1A;

FIG. 1C shows a second example display screen of the client device shown in FIG. 1A;

FIG. 1D shows a third example display screen of the client device shown in FIG. 1A;

FIG. 1E shows a fourth example display screen of the client device shown in FIG. 1A;

FIG. 1F shows a fifth example display screen of the client device shown in FIG. 1A;

FIG. 1G shows an example implementation of the system shown in FIG. 1A that enables customization of an extension for an operating system shell;

FIG. 1H shows an example implementation of the system shown in FIG. 1A that enables customization of an extension for an embedded browser of a resource access application;

FIG. 1I shows an example implementation of the system shown in FIG. 1A that enables customization of a browser that is separate from a resource access application;

FIG. 1J shows an example implementation of the system shown in FIG. 1A that enables customization of an extension for a Software-as-a-Service (SaaS) application;

FIG. 1K shows an example implementation of the system shown in FIG. 1A that enables customization of an extension for a native application;

FIG. 2 is a diagram of a network environment in which some embodiments of the system for customizing an application extension to enable use of microapps disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource management system, such as that shown in FIG. 5C, is employed;

FIG. 6A is a first sequence diagram illustrating example messages that may be exchanged amongst various components of the multi-resources access system shown in FIGS. 5A-C, as well as an operating system, in accordance with some embodiments of the present disclosure;

FIG. 6B is a second sequence diagram illustrating example messages that may be exchanged amongst various components of the multi-resources access system shown in FIGS. 5A-C, as well as an enterprise extension store, in accordance with some embodiments of the present disclosure;

FIG. 6C is a third sequence diagram illustrating example messages that may be exchanged amongst various components of the multi-resources access system shown in FIGS. 5A-C, as well as an extension store, in accordance with some embodiments of the present disclosure;

FIG. 6D is a fourth sequence diagram illustrating example messages that may be exchanged amongst various components of the multi-resources access system shown in FIGS. 5A-C in accordance with some embodiments of the present disclosure;

FIG. 6E is a fifth sequence diagram illustrating example messages that may be exchanged amongst various components of the multi-resources access system shown in FIGS. 5A-C in accordance with some embodiments of the present disclosure; and

FIG. 7 is a sequence diagram illustrating example interactions that may occur amongst various components of the multi-resources access system shown in FIGS. 5A-C when customized extensions of applications are used to invoke microapp actions as disclosed herein.

### DETAILED DESCRIPTION

For purposes of reading the description of the various embodiments below, the following descriptions of the sections of the specification and their respective contents may be helpful:

Section A provides an introduction to example embodiments of a system for customizing an application extension to enable use of microapps in accordance with some aspects of the present disclosure;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E describes embodiments of systems and methods for managing and streamlining access by clients to a variety of resources;

Section F provides a more detailed description of example embodiments of the systems introduced in Section A; and

Section G describes example implementations of methods, systems/devices, and computer-readable media in accordance with the present disclosure.

### A. Introduction to Illustrative Embodiments of a System for Customizing an Application Extension to Enable Use of Microapps

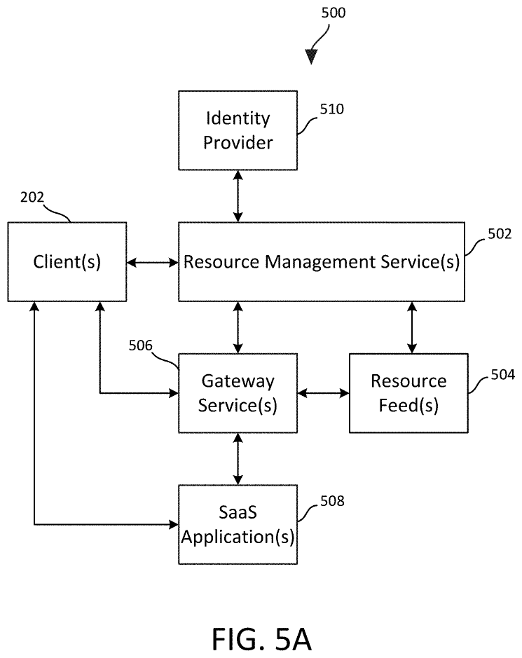

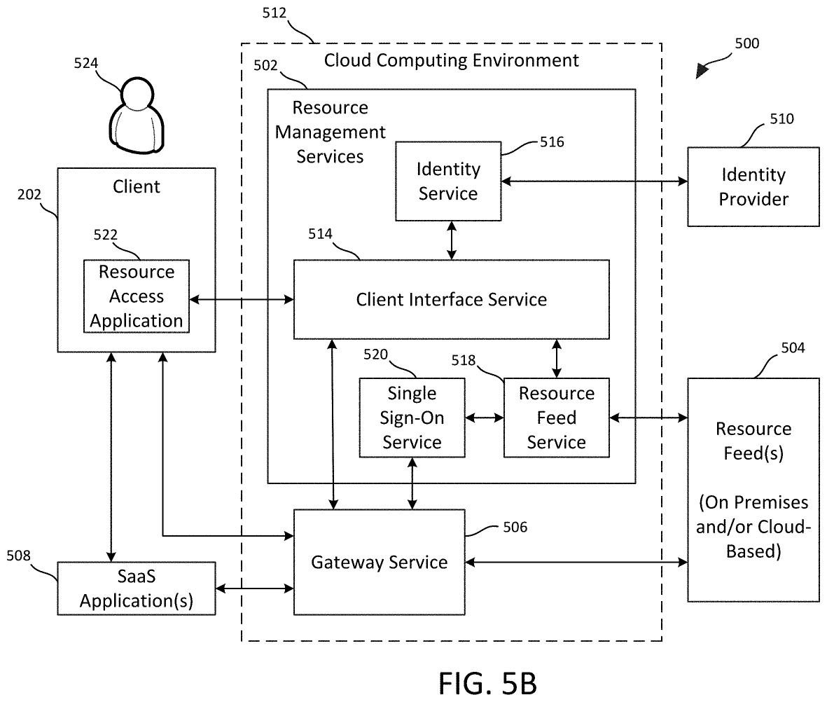

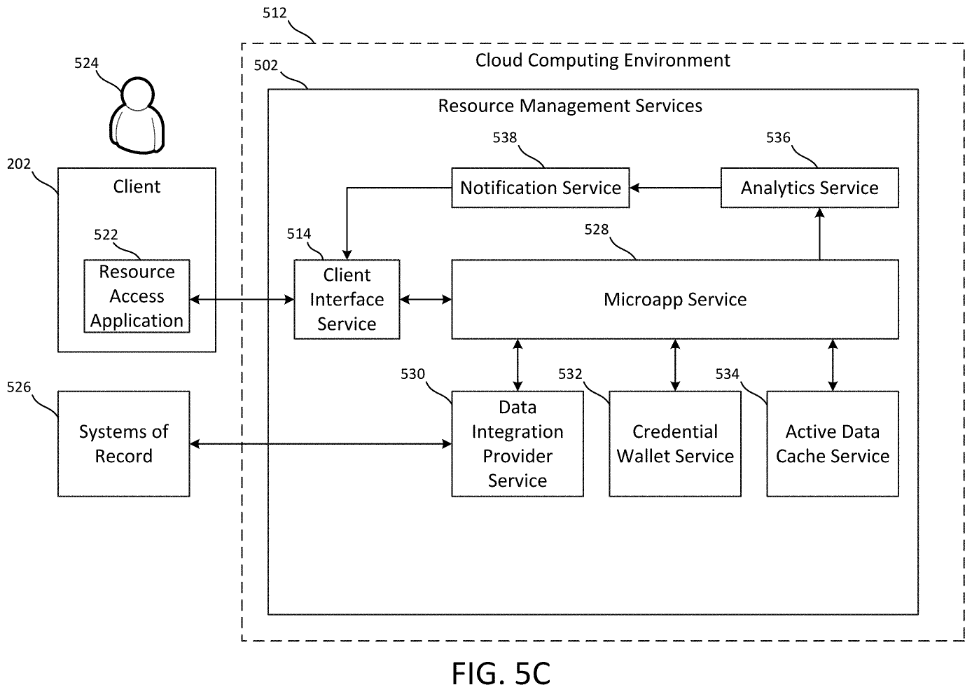

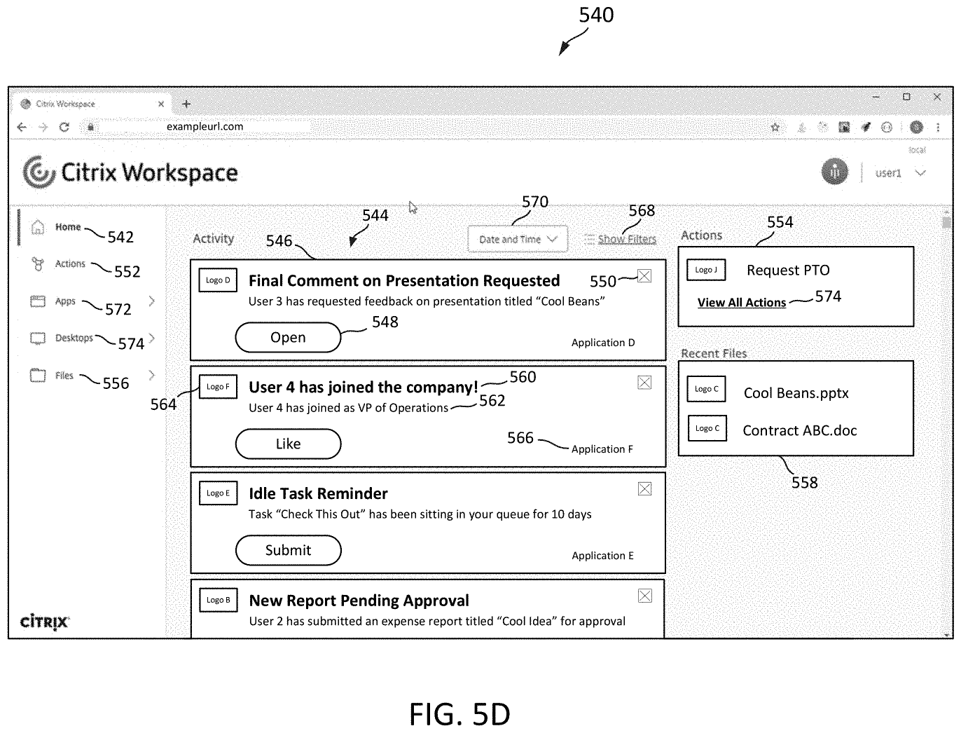

An intelligent activity feed, such as that offered by the Citrix Workspace™ family of products, provides significant benefits, as it allows a user to respond to application-specific events generated by disparate systems of record, without requiring the user to switch context and separately launch the respective applications to take actions with respect to the different events. An example of a system capable of providing such an activity feed is described in Section E below in connection with FIGS. 5A-D. In such a system, a remote computing system may be responsible for monitoring and interacting with various systems of record (e.g., Software-as-a Service (SaaS) applications, web applications, Windows applications, Linux applications, desktops, file repositories and/or file sharing systems, etc.) on behalf of a user operating a client device. As Section E describes (in connection with FIGS. 5C and 5D), a user 524 may operate a client device 202 so as to interact with “microapps” corresponding to particular functionalities of a variety of systems of record 526, and such microapps may, in turn, interact with the systems of record 526, e.g., via application programming interfaces (APIs) of such systems, on behalf of the user 524.

More specifically, and as described in more detail in Section E, a microapp service 528 (shown in FIG. 5C) may periodically request a sync with a data integration provider service 530, so as to cause active data to be pulled from the systems of record 526. In some implementations, for example, the microapp service 528 may retrieve encrypted service account credentials for the systems of record 526 from a credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to an analytics service 536 for processing. The analytics service 536 may create notifications (e.g., targeted scored notifications) and send such notifications to the notification service 538. The notification service 538 may store the notifications in a database to be later served in an activity feed and/or may send the notifications out immediately to the client 202 as a push notification to the user 524.

FIG. 5D, which is also described in more detail in Section E, shows how a display screen 540 presented by a resource access application 522 (shown in FIG. 5C) may appear when an intelligent activity feed feature is employed and a user 524 is logged on to the system. As shown in FIG. 5D, an activity feed 544 may be presented on the display screen 540 that includes a plurality of notifications 546 about respective events that occurred within various applications to which the user 524 has access rights. As described below (in connection with FIG. 5D), in some implementations, when presented with such an activity feed 544, the user 524 may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550.

As explained in connection with FIG. 5C below, the notifications 546 and corresponding action elements 548 may be implemented, for example, using “microapps” that can read and/or write data to systems of record 526 using application programming interface (API) functions or the like, rather than by performing full launches of the applications for such systems of record 526. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user interface elements 548, 550.

In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of available microapp actions. In some implementations, the various microapp actions available to the user 524 logged onto the multi-resource access system 500 may be enumerated to the resource access application 522, e.g., when the user 524 initially accesses the system 500, and the list 554 may include a subset of those available microapp actions. The available microapp actions may, for example, be organized alphabetically based on the names assigned to the actions, and the list 554 may simply include the first several (e.g., the first four) microapp actions in the alphabetical order. In other implementations, the list 554 may alternatively include a subset of the available microapp actions that were most recently or most commonly accessed by the user 524, or that are preassigned by a system administrator or based on some other criteria. The user 524 may also access a complete set of available microapp actions, in a similar manner as the “action” user interface element 552, by clicking on the “view all actions” user interface element 574.

The inventor has recognized and appreciated that circumstances may arise in which a user 524 controlling an application (referred to herein as a “user app”), e.g., Microsoft Outlook, via a client device 202 may determine it would be useful to invoke a microapp, e.g., via the microapp service 528, to take a particular action with respect to a system of record 526, e.g., Jira. For example, a user 524 reading an email may determine that it would be beneficial to use a microapp to push a task described in the email to Jira. Using the multi-resource access system 500 described in Section E, in order to access the desired microapp to take such an action, the user 524 would need to switch context from the user app (e.g., Microsoft Outlook) to access the user interface for the resource access application 522 (e.g., the display screen 540 shown in FIG. 5D). This need to switch context away from the application currently in use may result in a poor user experience, and may even discourage the user 524 from opting to use a microapp to take the desired action. As described in co-pending U.S. application Ser. No. 16/902,867, one solution to this problem is to enhance respective user apps, e.g., with add-ins or extensions, that enable the user to access user interface (UI) controls for microapps directly from such user apps. For instance, the aforementioned patent application teaches how a web browser (i.e., a type of user app) that is used to access SaaS applications may be enhanced for such a purpose, or how other types of user apps (e.g., Microsoft Word) may be enhanced in such a way. Although such a solution may provide significant benefits in many circumstances, the administrative burden and expense of creating, installing, and maintaining such extensions may limit their widespread adoption and use. Additionally, the degree of customization that is enabled by the “tagging” of microapp actions to trigger the availability of microapp UI controls for those actions (e.g., in response to a mouse right-click) may be too limited for certain use cases. Further, the inventor has recognized and appreciated that, in existing systems, it is also not possible to invoke a microapp action directly from a shell application for an operating system, such as the File Explorer for Microsoft Windows (formerly called Windows Explorer).

Offered are systems and techniques that enable the robust customization of one or more application extensions for enabling access to microapp UI controls for a particular user or group of users. In some implementations, for example, using the techniques described herein, an application extension may be customized for a particular user/group to specify (A) the types of microapp actions for which UI controls are to be made available, (B), the contextual circumstances in which such microapp UI controls are to be presented in response to triggering actions, (C) one or more particular actions (e.g., a right-click, a shortcut key, etc.) that are to trigger the presentation of such microapp UI controls under the indicated circumstances, and/or (D) one or more actions that are to be taken using a result that is returned from a system of record 526 in response to the invoked microapp taking the indicated action with respect to that system of record 526. In some implementations, configuration data (referred to herein as “microapp correlation data”) may be used to map particular microapp actions to corresponding conditions, triggering events, and/or result-based actions. Several examples of possible conditions, triggering events, and result-based actions are provided further below.

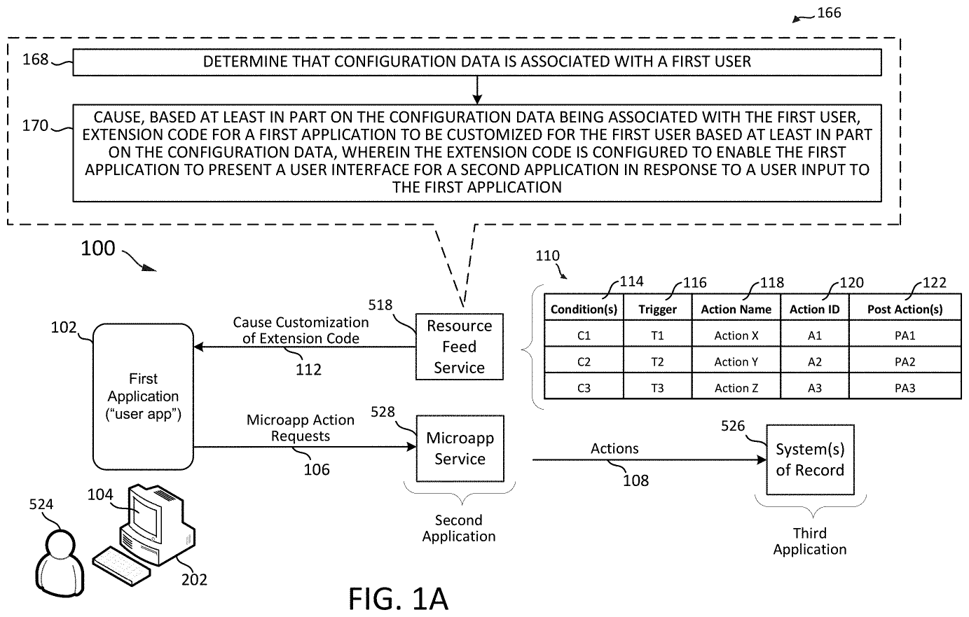

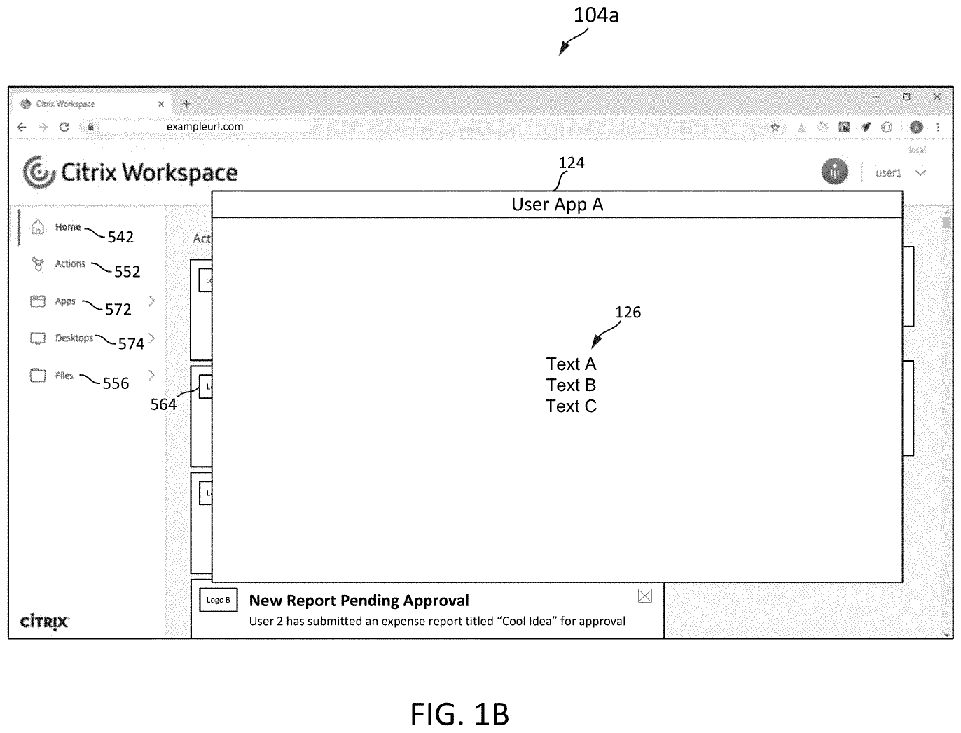

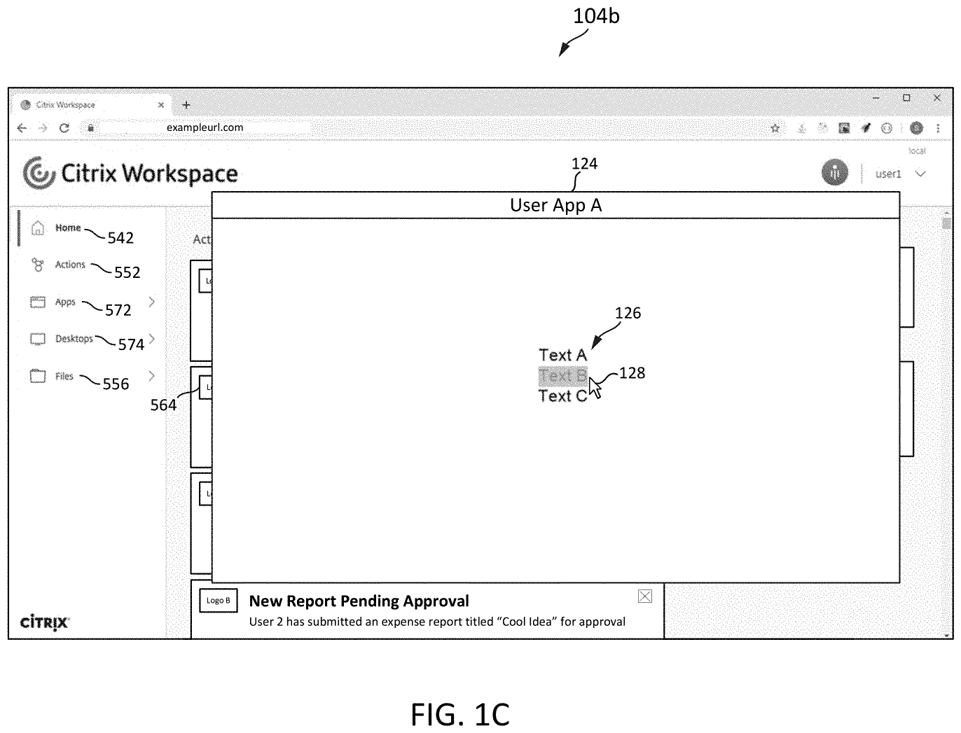

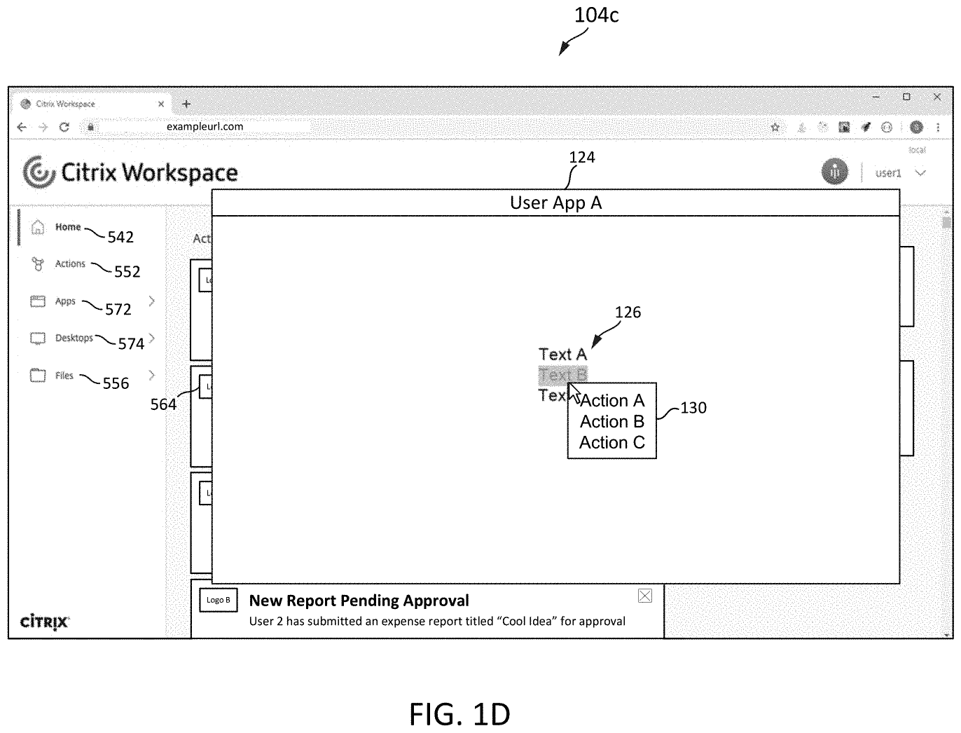

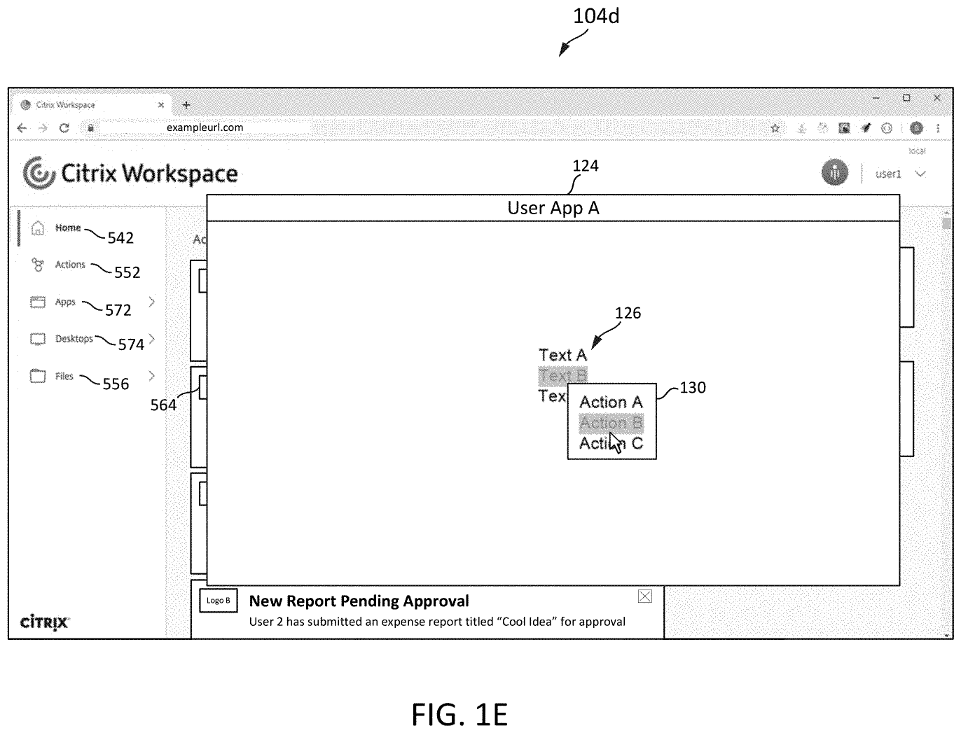

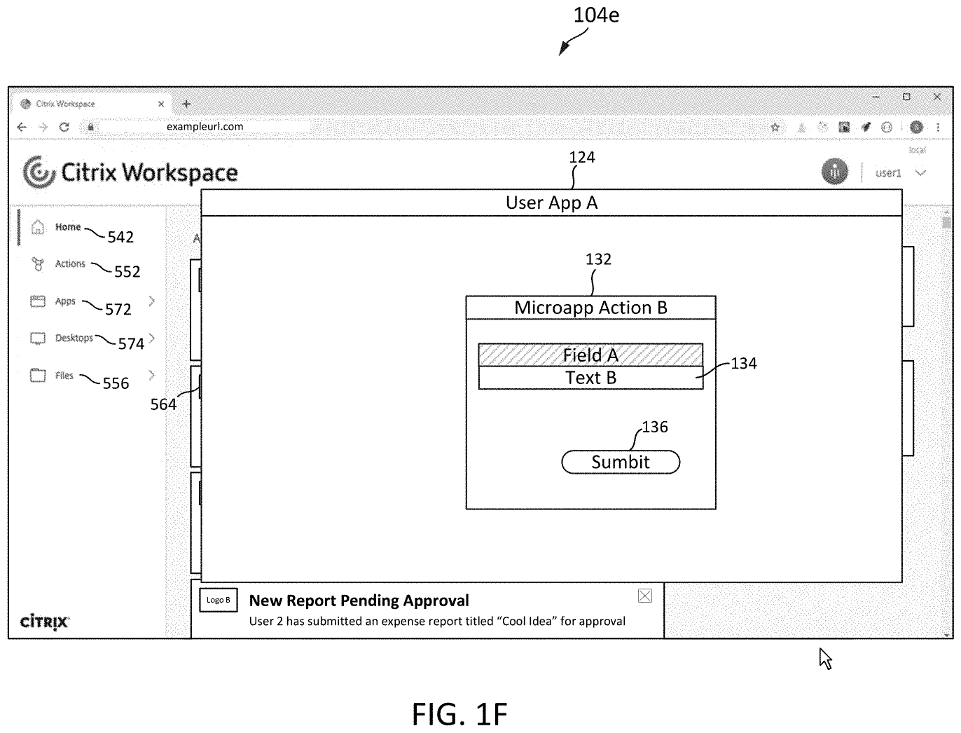

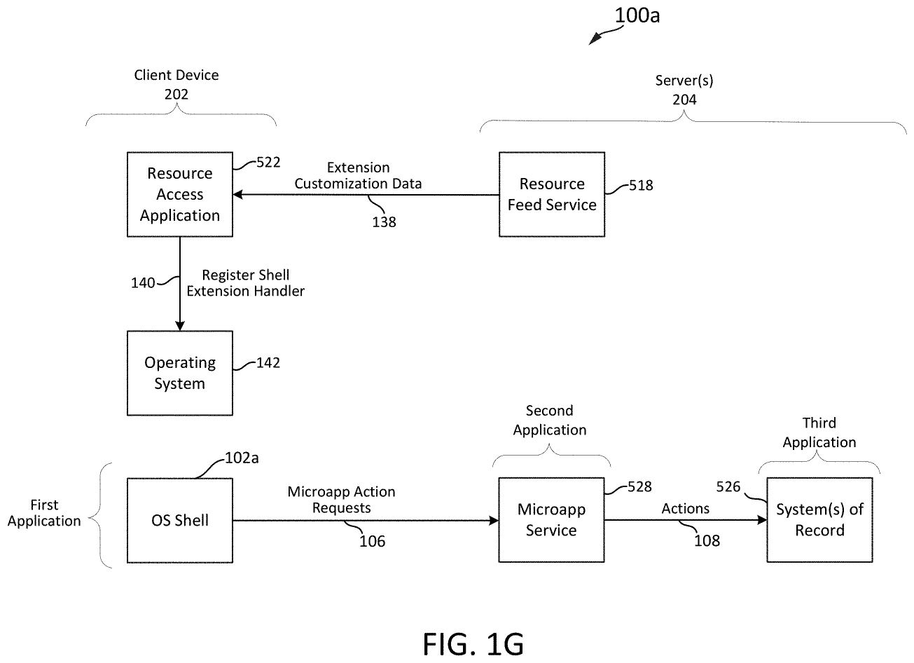

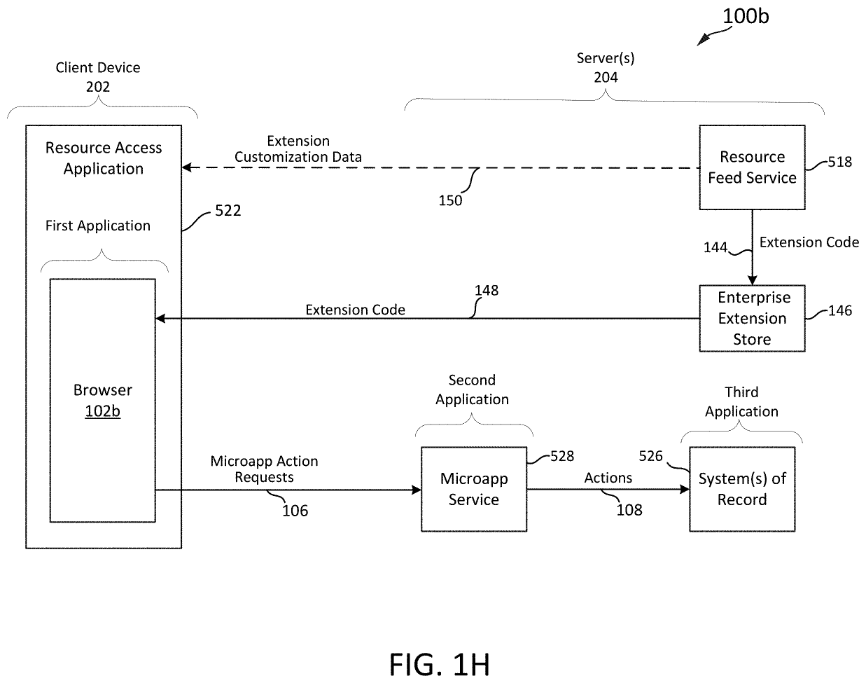

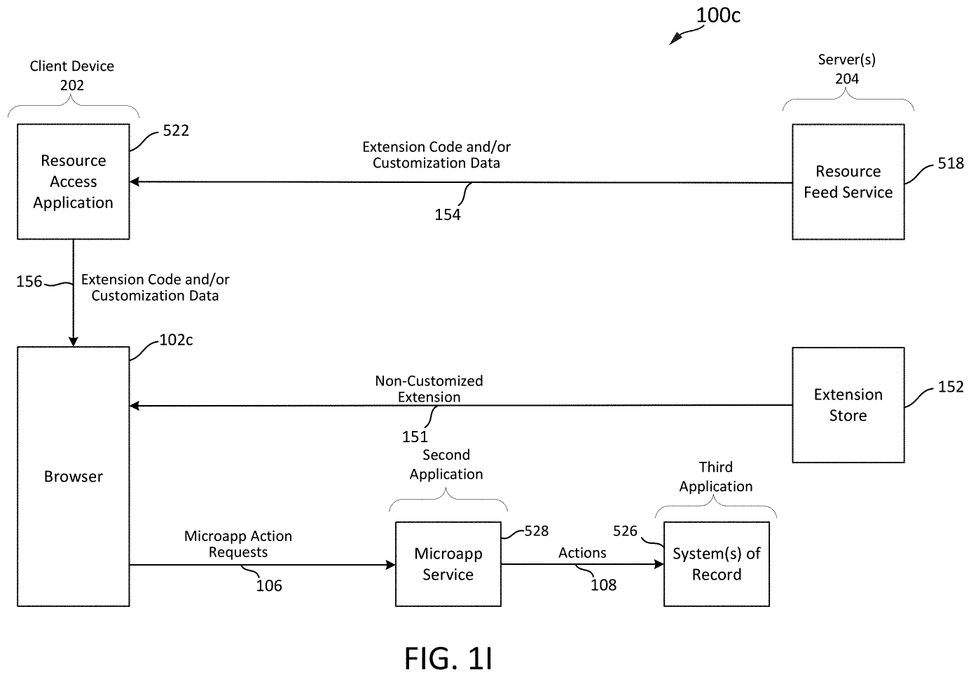

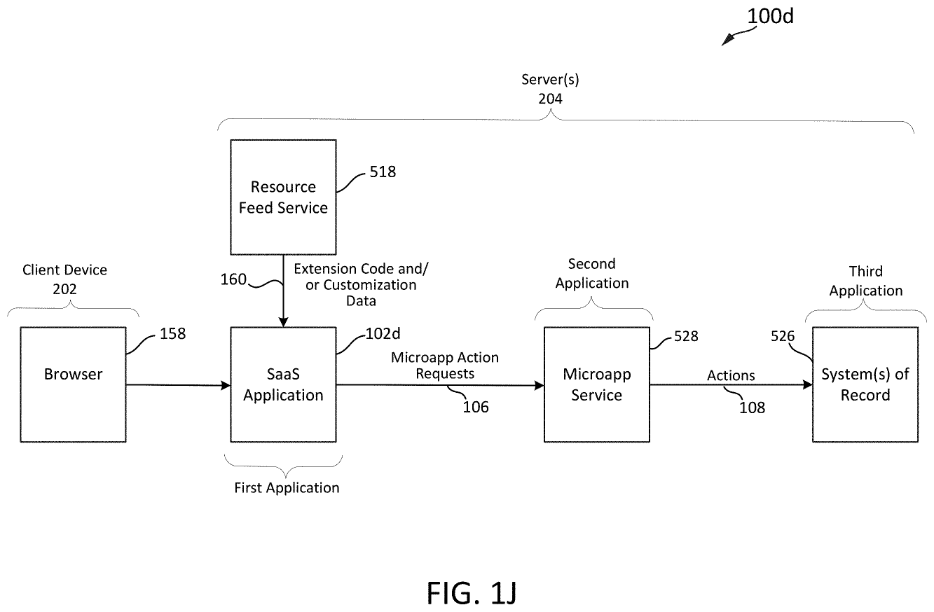

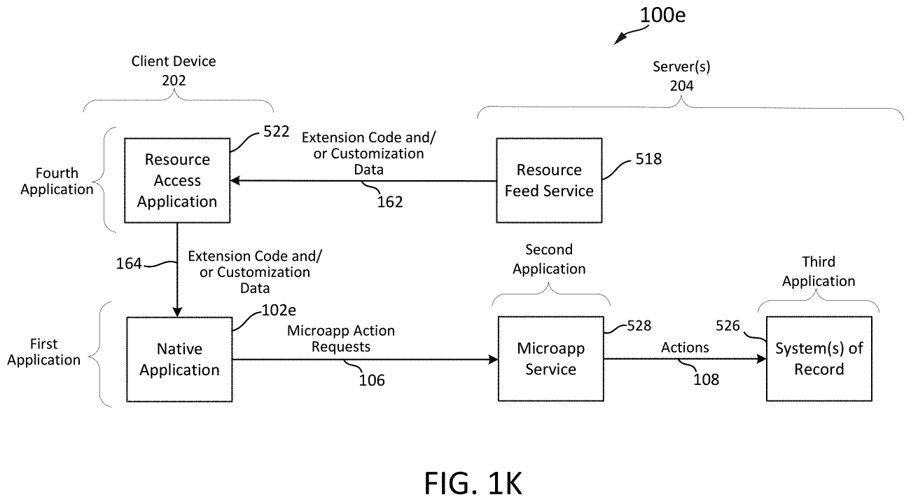

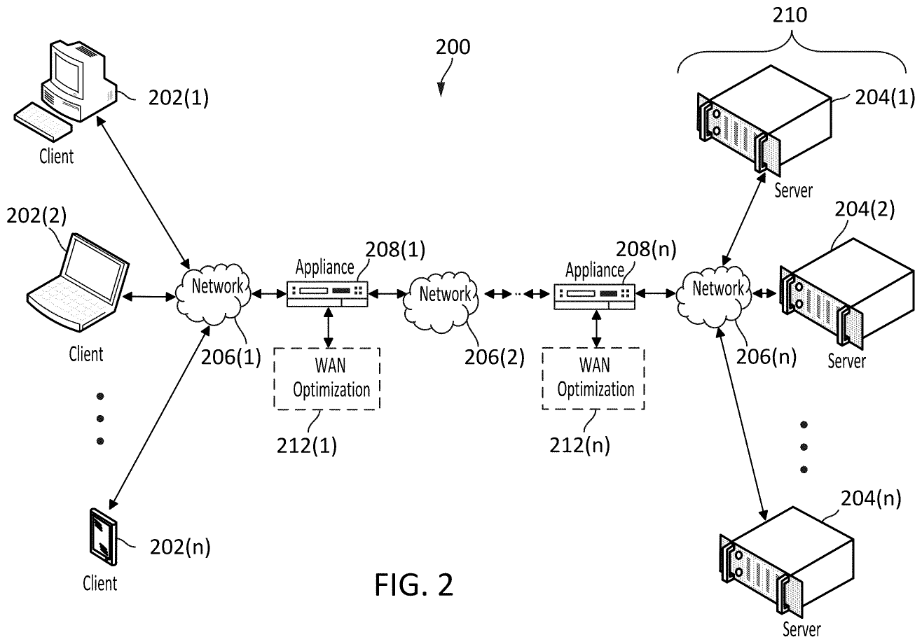

FIG. 1A shows an example system 100 in which extension code for a first application 102 (alternatively referred to herein as a “user app”) may be customized to control the circumstances in which a user 524 operating a client device 202 (examples of which are described below in connection with FIGS. 2-4) may invoke one or more microapp actions directly from the user app 102 and/or the manner in which data returned by a system of record 526 as a result of a microapp action is processed by the user app 102. As explained in more detail below in connection with FIGS. 1G-K, the user app 102 may be any of a number of applications, such as (1) an operating system shell 102a (e.g., see FIG. 1G), (2) a web browser 102b embedded in the resource access application 522 (e.g., see FIG. 1H), (3) a web browser 102c separate from the resource access application 522 (e.g., see FIG. 1I), (4) a SaaS application 102d (e.g., see FIG. 1J), 5) a native application 102e (e.g., see FIG. 1H), etc. Examples implementations in which one or more servers 204 (examples of which are described below) may cause extensions for such different types of user apps 102 to be customized for the user 524 are described further below.

In the example shown in FIG. 1A, the microapp that is configured to perform the microapp action is designated as the “second application,” and the system of record 526 with respect to which the microapp action is to be performed is designated as the “third application.” As shown, the client device 202 may include a display screen 104 on which user interfaces for various applications accessed by the client device 202 may be presented. As indicated by an arrow 106 in FIG. 1A, upon selecting a microapp action to be invoked (as described below), the client device 202 may send an action request to the microapp service 528. And, upon receiving such an action request, a microapp of the microapp service 528 may, as indicated by an arrow 108 in FIG. 1A, take one or more steps to take the requested action with respect to a particular system of record 526 on behalf of the user 524 (e.g., via one or more APIs of the system of record 526).

As explained in more detail below, in some implementations, the resource feed service 518 (or another server-based computing system) may use microapp correlation data 110 (shown adjacent the resource feed service 518 in FIG. 1A) associated with the user 524 (or a group of users including the user 524) to determine how to customize extension code, e.g., as indicated by an arrow 112 in FIG. 1A, of the user app 102 for the user 524. As shown, in some implementations, the microapp correlation data 110 may include “condition(s)” entries 114, “trigger” entries 116, “action name” entries 118, “action ID” entries 120, and “post action(s)” entries 122. In some implementations, the “condition(s)” entries 114 may include data that the resource feed service 518 uses to determine whether other data in the same row is to be used to customize the extension code for a particular user app 102. For example, the “condition(s)” entries 114 may include data indicating that the remainder of the data of the row is applicable only to a particular class of user app 102 (e.g., browsers), only to a particular type of user app 102 (e.g., a Firefox browser), only to an operating system shell extension, etc. Alternatively, the microapp correlation data 110 may include another column of data (e.g., “application” entries—not illustrated in FIG. 1A) that may be used for such a purpose.

The resource feed service 518 may cause the extension code for a particular user app 102 to be customized based on the microapp correlation data 110 in any of a number of ways. For example, in some implementations, the resource feed service 518 may use the microapp correlation data 110 to generate and/or select portions of extension code that are to be provided to the user app 102. Additionally or alternatively, in some implementations, the resource feed service 518 may provide some or all of the microapp correlation data 110 to the user app 102 such that the microapp correlation data 110 may control the behavior of extension code for the user app 102 to at least some extent. The extension code that is so controlled may be installed on the user app 102 before the microapp correlation data 110 (or a portion thereof) is provided to the user app 102, or may be provided to the user app 102 together with or subsequent to the microapp correlation data 110 (or portion thereof).

FIGS. 1B-F show example instantiations of the display screen 104 of the client device 202, labeled with reference numerals 104a-e, respectively, illustrating microapp-related functionality that may be enable by the extension code for a user app 102 (referred to as “User App A”) after that extension code has been customized for the user 524 based on the microapp correlation data 110.

As shown in FIG. 1B, the display screen 104a may present a window 124 or other user interface for User App A. In some circumstances, the window 124 may, for example, have been displayed in response to the user selecting User App A from a list of applications presented when the user clicked on the “Apps” user interface element 572. In other circumstances, User App A may have been accessed in other ways, such as by taking one or more steps independent of the resource access application 522 to launch or otherwise access the user app. In some implementations, for example, the user may have simply selected an icon for the user app on the user's desktop, thus causing User App A to launch. As shown, the window 124 may include content 126, such as text, file icons, etc.

As shown in FIG. 1C, the user 524 may cause a portion of the displayed content 126 to be selected, e.g., by moving a cursor 128 while clicking and holding a mouse button, by hovering over or clicking on a file icon, etc. In the illustrated example, the user 524 has selected the text “Text B” within the window 124.

As shown in FIG. 1D, the customized extension code of the user app 102 may cause a user interface menu 130 identifying available microapp actions to be presented in response to the user 524 providing a particular type of input to the client device 202 (e.g., by right-clicking a mouse). In the illustrated example, the user interface menu 130 identifies three available microapp actions, including “Action A,” “Action B,” and “Action C.”

In some implementations, the microapp actions that are identified in the user interface menu 130 may be based on the microapp correlation data 110. For example, in some implementations, the text of the items within the user interface menu 130 may correspond to respective “action name” entries 118 in the microapp correlation data 110, and the extension code for the user app 102 may have been customized (based on the microapp correlation data 110) to cause respective microapp actions to be identified in the user interface menu 130 only if the user app 102 determines that both (A) the condition indicated in the “condition” entry 114 for the item is met, and (B) the triggering event indicated in the “trigger” entry 116 for the microapp action has occurred. For different microapp actions, the respective “condition” entries 114 may specify one or more potential operational states of the user app 102 and/or one or more other conditions relating to the client device 202 or one or more other components of the system 100. As just a few examples, the operational state(s) specified by respective condition entries 114 may include one or more of (A) that a particular type of page or other output is being presented by the user app 102, (B) that selected text (e.g., as described in connection with FIG. 1C) contains or matches a particular string, (C) that a selected and/or opened file is of a particular type (e.g., .docx), and so on. The “trigger” entries 116 may specify particular user input types, e.g., a right-click, one or more shortcut keys, etc., that are to trigger the customized extension code of the user app 102 to generate and present the user interface menu 130 including the corresponding action names when the indicated condition is satisfied.

As shown in FIG. 1E, the user 524 may select one of the action names presented in the user interface menu 130 presented by the customized extension code for the user app 102, such as by hovering the cursor over the action name and left-clicking the mouse. In the illustrated example, the user has selected the action name “Action B.”

As shown in FIG. 1F, in response to the user 524 selecting “Action B” within the user interface menu 130, the customized extension code for the user app 102 may cause the client device 202 to present a user interface window 132 for that microapp action, i.e., “Microapp Action B.” In some implementations, the customized extension of the user app 102 may retrieve the content and UI controls of the user interface window 132 from a remote source, e.g., from the microapp service 528. For example, in some implementations, the “action ID” entry 120 corresponding to the selected action name in the microapp correlation data 110, may be used by the customized extension code to identify and/or retrieve the content and UI controls for the user interface window 132 from the microapp service 528. In other implementations, the “action ID” entries 120 may themselves include the content and UI controls, or point to locally stored content and UI controls, for user interface window 132 for particular microapp actions.

As also shown in FIG. 1F, in some implementations, the customized extension code of the user app 102 may further cause the user interface window 132 to include, e.g., within a fillable field 134 of the user interface window 132, the content in the window 124 of User App A that was previously selected, e.g., as shown in FIG. 1C. In the illustrated example, the customized extension of the user app 102 has caused the selected text “Text B” to appear within the fillable field 134 for the field “Field A.” Upon selection of a user interface element 136, e.g., a “submit” button, in the user interface window 132, the customized extension of the user app 102 may send an action request (e.g., as indicated by the arrow 106 in FIG. 1A) to the microapp service 528, instructing the microapp service 528 to take the indicated action with respect to a system of record 526, e.g., as indicated by the arrow 108 in FIG. 1A. In at least some circumstances, to execute the action, the system of record 526 may use the selected content from the window 124 of the user app 102 that the customized extension had inserted into the user interface window 132.

Referring again to FIG. 1D, in some implementations, rather than presenting the user interface menu 130 (including a list of available actions) in response to detecting a particular trigger input while the conditions(s) specified by a “condition(s)” entry 114 are satisfied, the customized extension of the user app 102 may instead immediately present a user interface window 132 (e.g., as shown in FIG. 1F) for a particular microapp action. For instance, in some such implementations, different keyboard shortcuts may be specified to directly invoke respective microapp actions, such as by designating “ALT-J” as a trigger input for a “Send task to Jira” microapp action, “ALT-C” as a trigger input for “Submit expense report to Concur,” etc.

Although not illustrated in FIGS. 1A-F, in some implementations, after taking the requested action with respect to a system of record 526, the microapp service 528 may receive data indicative of a result of the executed action from the system of record 526, and may pass that data to the customized extension of the user app 102. In some implementations, the customized extension of the user app 102 may take one or more additional steps to cause the returned data to be input into the user app 102 or a user interface for the user app 102, e.g., the window 124. In some implementations, the “post-action(s)” entries 122 of the microapp correlation data 110 may specify the additional step(s) that are to be taken by the customized extension of the user app 102 upon receiving such result data (e.g., from a microapp of the microapp service 528).

FIG. 1G illustrates an example configuration 100a of the system 100 shown in FIG. 1A, where the first application 102 is an operating system shell 102a, such as the File Explorer for Microsoft Windows (formerly called Windows Explorer). As illustrated, to customize an extension of the operating system shell 102a, in some implementations, the resource feed service 518 may provide extension customization data (e.g., as indicated by an arrow 138) to the resource access application 522 on the client device 202. Based on that extension customization data, the resource access application 522 may (e.g., as indicated by an arrow 140) register one or more shell extension handlers with the operating system 142. Such shell extension handlers are described, for example, at the path “en-us/windows/win32/shellhandlers” of the uniform resource locator (URL) “docs.microsoft.com,” the entire contents of which are incorporated herein by reference. The extension customization data (indicated by the arrow 138) may, for example, include one or more component object model (COM) objects embodying the extension handlers that the resources access application 522 is to register with the operating system 142. In some implementations, such COM objects may be configured by the resource feed service 518 based on the microapp correlation data 110 described above in connection with FIG. 1A. Additionally or alternatively, the extension customization data that the resources feed service 518 provides to the resource access application 522 may include some or all of the microapp correlation data 110 associated with the user 524. In some such implementations, such microapp correlation data 110 may be used by the resource access application 522 to configure one or more COM objects so as to customize extension handler(s) for the user 524 prior to registering such extension handler(s) with the operating system 142.

Once the resource access application 522 has registered the customized shell extension handler(s) with the operating system 142, the user 524 may interact with the operating system shell 102a to access one or more user interface features for microapps, such as user interface menu 130 and user interface window 132 described above in connection with FIGS. 1D-F. As one example, a registered shell extension handler may be configured (based on the microapp correlation data 110) so that if a user right clicks on a .pdf file, the user may be presented with an option to invoke a microapp action to “Send file to RightSignature.” In some implementations, for example, a “condition(s)” entry 114 of the microapp correlation data 110 may have specified that a condition under which the “Send file to RightSignature” microapp action is to be made accessible is the selection of a file of the type “pdf,” and a corresponding “trigger” entry 116 of the microapp correlation data 110 may have specified “right mouse click” as a triggering action that is to cause the microapp action to be made accessible when the specified condition is satisfied. Upon invoking such a microapp action, the customized extension of the operating system shell 102a may send a microapp action request to the microapp service 528 (as indicated by the arrow 106 in FIG. 1G), and the microapp service 528 may take the indicated action with respect to a system of record 528, e.g., RightSignature (as indicated by the arrow 108 in FIG. 1G).

FIG. 1H illustrates another example configuration 100b of the system 100 shown in FIG. 1A, where the first application 102 is a browser 102b that is embedded within or otherwise accessible to the resource access application 522. In some implementations, for example, the browser 102b may be the specialized browser described in Section E. As Section E describes, the specialized browser may be embedded within the resource access application 522 (as illustrated in FIG. 1H), or may be delivered to the resource access application 522 by one of the resource feeds 504 shown in FIG. 5B, e.g., via a secure browser service. As illustrated, to customize an extension of the browser 102b, in some implementations the resource feed service 518 may, as indicated by an arrow 144, provide extension code to an enterprise extension store 146 that is accessible to the browser 102b, and the browser 102b may be configured to retrieve that extension code from the enterprise extension store 146, as indicated by an arrow 148. In some implementations, the enterprise extension store 146 may be included amongst the resource management services 502 shown in FIGS. 5B and 5C. In some implementations, the resource feed service 518 may customize the extension code for respective users (or a group of users) based on the microapp correlation data 110 (described above in connection with FIG. 1A) associated with such users (or groups of users) such that the extension code the browser 102b retrieves from the enterprise extension store 146 is customized for the user 524 operating the browser 102b.

Further, in some implementations, as indicated by an arrow 150 in FIG. 1H, the resource feed service 518 may additionally or alternatively provide extension customization data to the resource access application 522. Such extension customization data may, for example, include some or all of the microapp correlation data 110 associated with the user 524. In some implementations, the browser 102b may use such extension customization data to customize, or further customize, the extension code that the browser 102b retrieves from the enterprise extension store 146.

Once the customized extension code for the browser 102b is in place, the user 524 may interact with the browser 102b to access one or more user interface features for microapps, such as user interface menu 130 and user interface window 132 described above in connection with FIGS. 1D-F. As one example, the extension code of the browser 102b may be customized (based on the microapp correlation data 110) so that if the user 524 presses “Alt-J” when the browser 102b is pointed to a particular URL domain (e.g., for a Microsoft Office SaaS application), the user 524may be presented with an option to invoke a microapp action to “Send task to Jim.” In some implementations, for example, a “condition(s)” entry 114 of the microapp correlation data 110 may have specified that a condition under which the “Send task to Jira” microapp action is to be made accessible is the browser 102b being pointed to the particular domain, and a corresponding “trigger” entry 116 of the microapp correlation data 110 may have specified “Alt-J” as a triggering action that is to cause the microapp action to be made accessible when the specified condition is satisfied. Upon invoking such a microapp action, the customized extension of the browser 102b may send a microapp action request to the microapp service 528 (as indicated by the arrow 106 in FIG. 1H), and the microapp service 528 may take the indicated action with respect to a system of record 528. e.g., Jira (as indicated by the arrow 108 in FIG. 1G).

FIG. 1I illustrates another example configuration 100c of the system 100 shown in FIG. 1A, where the first application 102 is a browser 102c that is separate from the resource access application 522. The browser 102c may be any of a number of web browsers that can execute under control of the client device 202, such as a Microsoft Explorer Browser, a Google Chrome Browser, a Mozilla Firefox browser, etc. As indicated by an arrow 151 in FIG. 1I, the browser 102c may retrieve code for a non-customized extension for the browser 102c from an extension store 152. The extension store 152 may, for example, be the Internet Explorer Gallery, the Chrome Web Store, the Firefox Browser Add-Ons website, etc. In some implementations, an administrator of the system 100 may, for example, publish the non-customized extension on the extension store 152, and the user 524 of the client device 202 may operate the browser 102c to visit the extension store 152 and download/install the code for the non-customized extension.

Further, as indicated by an arrow 154 in FIG. 1I, to enable an extension of the browser 102c to be customized for the user 524, the resource feed service 518 may additionally provide additional extension code and/or customization data to the resource access application 522. The non-customized extension of the browser 102c may be configured to retrieve the additional extension code and/or customization data from the resource access application 522, as indicated by an arrow 156, and may use that additional extension code and/or customization data to implement an extension that is customized for the user, e.g., based on the microapp correlation data 110 described in connection with FIG. 1A. In some implementations, the resource feed service 518 may generate customized extension code for respective users (or a group of users) based on the microapp correlation data 110 (described above in connection with FIG. 1A) associated with such users (or groups of users) such that the extension code that the resource feed service 518 sends to the resource access application 522, and that the browser 102c retrieves from the resource access application 522 (per the arrow 156), is customized for the user 524 operating the browser 102c.

Further, in some implementations, the resource feed service 518 may additionally or alternatively provide extension customization data to the resource access application 522. Such extension customization data may, for example, include some or all of the microapp correlation data 110 associated with the user 524. In some implementations, the browser 102c may use such extension customization data to customize the non-customized extension (retrieved per the arrow 151) and/or to customize, or further customize, the extension code that the browser 102c receives from the resource access application 522 (per the arrow 156).

Once the customized extension code for the browser 102c is in place, the user 524 may interact with the browser 102c to access one or more user interface features for microapps, such as user interface menu 130 and user interface window 132 described above in connection with FIGS. 1D-F. As one example, the extension code of the browser 102c may be customized (based on the microapp correlation data 110) so that if a user 524 right-clicks while hovering over a link to a .pdf document, the user 524 may be presented with an option to invoke a microapp action to “Upload to ShareFile.” In some implementations, for example, a “condition(s)” entry 114 of the microapp correlation data 110 may have specified that a condition under which the “Upload to ShareFile” microapp action is to be made accessible is the hovering of a cursor over a link to a .pdf document, and a corresponding “trigger” entry 116 of the microapp correlation data 110 may have specified “right-click” as a triggering action that is to cause the microapp action to be made accessible when the specified condition is satisfied. Upon invoking such a microapp action, the customized extension of the browser 102c may send a microapp action request to the microapp service 528 (as indicated by the arrow 106 in FIG. 1I), and the microapp service 528 may take the indicated action with respect to a system of record 528. e.g., ShareFile® (as indicated by the arrow 108 in FIG. 1I).

FIG. 1J illustrates yet another example configuration 100d of the system 100 shown in FIG. 1A, where the first application 102 is a SaaS application 102d that may be accessed via a browser 158 executing under control of the client device 202. The browser 158 may be either embedded within a resource access application 522 (like the browser 102b described in connection with FIG. 1H) or may be separate from the resource access application 522 (like the browser 102c described in connection with FIG. 1J). The SaaS application 102d may be configured such that one or more extensions of the SaaS application 102d may be selectively installed and/or configured for a particular user, e.g., via one or more API commands received from the resource feed service 518. As one example, the SaaS application may be a Microsoft Office 365 application and an administrator of the system 100 may enable the resource feed service 518 to install and/or configure one or more extensions/add-ins of the SaaS application 102d.

As indicated by an arrow 160 in FIG. 1J, to enable an extension of the SaaS application 102d to be customized for the user 524, the resource feed service 518 may provide extension code and/or customization data to the SaaS application, and may instruct the SaaS application 102d to install and/or configure an extension of the SaaS application 102d, e.g., via one or API commands. In some implementations, the resource feed service 518 may generate customized extension code for respective users (or a group of users) based on the microapp correlation data 110 (described above in connection with FIG. 1A) associated with such users (or groups of users) such that the extension code that the resource feed service 518 provides to the SaaS application 102d is customized for the user 524 operating the browser 158.

Further, in some implementations, the resource feed service 518 may additionally or alternatively provide extension customization data to the SaaS application 102d. Such extension customization data may, for example, include some or all of the microapp correlation data 110 associated with the user 524. In some implementations, the SaaS application 102d may use such extension customization data to customize a non-customized extension of the SaaS application 102d and/or to customize, or further customize, the extension code that the resource feed service 518 provides to the SaaS application 102d (per the arrow 160).

Once the customized extension code for the SaaS application 102d is in place, the user 524 may interact with the SaaS application 102d (e.g., via the browser 158) to access one or more user interface features for microapps, such as user interface menu 130 and user interface window 132 described above in connection with FIGS. 1D-F. As one example, the extension code of the SaaS application 102d may be customized (based on the microapp correlation data 110) so that if a user right-clicks after selecting text containing one or more particular strings, the user may be presented with an option to invoke a microapp action to “Submit Expense Report to Concur.” In some implementations, for example, a “condition(s)” entry 114 of the microapp correlation data 110 may have specified that a condition under which the “Submit Expense Report to Concur” microapp action is to be made accessible is the selection of text including the symbol “$,” and a corresponding “trigger” entry 116 of the microapp correlation data 110 may have specified “right-click” as a triggering action that is to cause the microapp action to be made accessible when the specified condition is satisfied. Upon invoking such a microapp action, the customized extension of the SaaS application 102d may send a microapp action request to the microapp service 528 (as indicated by the arrow 106 in FIG. 1J), and the microapp service 528 may take the indicated action with respect to a system of record 528. e.g., Concur (as indicated by the arrow 108 in FIG. 1J).

FIG. 1K illustrates still another example configuration 100e of the system 100 shown in FIG. 1A, where the first application 102 is a native application 102e (other than a browser) executing under control of the client device 202. The native application 102e may be configured such that one or more extensions of the native application 102e may be selectively installed and/or configured for a particular user, e.g., via one or more API commands received from the resource access application 522. As one example, the native application 102e may be a Microsoft Outlook application installed on the client device 202 together with the resource access application 522, and the user 524 of the client device 202 may enable the resource access application 522 to install and/or configure one or more extensions/add-ins of the native application 102e.

As indicated by an arrow 162 in FIG. 1K, to enable an extension of the native application 102e to be customized for the user 524, the resource feed service 518 may provide extension code and/or customization data to the resource access application 522 so as to enable the resource access application 522 instruct the native application 102e to install and/or configure an extension of the native application 102e, e.g., via one or API commands. In some implementations, the resource feed service 518 may generate customized extension code for respective users (or a group of users) based on the microapp correlation data 110 (described above in connection with FIG. 1A) associated with such users (or groups of users) such that the extension code that the resource feed service 518 provides to the resource access application 522 is customized for the user 524 operating the native application 102e.

Further, in some implementations, the resources feed service 518 may additionally or alternatively provide extension customization data to the native application 102e (via the resource access application 522—per the arrows 162 and 164 in FIG. 1K). Such extension customization data may, for example, include some or all of the microapp correlation data 110 associated with the user 524. In some implementations, the native application 102e may use such extension customization data to customize a non-customized extension of the native application and/or to customize, or further customize, the extension code that the resource feed service 518 provides to the native application 102e (via the resource access application 522—per the arrows 162 and 164 in FIG. 1K).

Once the customized extension code for the native application 102e is in place, the user 524 may interact with the native application 102e to access one or more user interface features for microapps, such as user interface menu 130 and user interface window 132 described above in connection with FIGS. 1D-F. As one example, the extension code of native application 102e may be customized (based on the microapp correlation data 110) so that if a user right-clicks when an email is open in a foreground window, the user may be presented with an option to invoke a microapp action to “Submit PTO request to Workday.” In some implementations, for example, a “condition(s)” entry 114 of the microapp correlation data 110 may have specified that a condition under which the “Submit PTO request to Workday” microapp action is to be made accessible is the display of an open email in the foreground, and a corresponding “trigger” entry 116 of the microapp correlation data 110 may have specified “right-click” as a triggering action that is to cause the microapp action to be made accessible when the specified condition is satisfied. Upon invoking such a microapp action, the customized extension of the native application 102e may send a microapp action request to the microapp service 528 (as indicated by the arrow 106 in FIG. 1K), and the microapp service 528 may take the indicated action with respect to a system of record 528. e.g., Workday (as indicated by the arrow 108 in FIG. 1K).

FIG. 1A additionally shows an example routine 166 that may be performed by one or more components of the system 100 (e.g., the resource feed service 518) in accordance with some aspects of the present disclosure. As shown in FIG. 1A, at a step 168 of the routine 166, the resource feed service 518 may determine that configuration data (e.g., the microapp correlation data 110) is associated with a first user (e.g., the first user 524 or a group of users to which the first user 524 belongs).

At a step 170 of the routine 166, the resource feed service 518 may cause (based at least in part on the configuration data, e.g., the microapp correlation data 110, being associated with the first user) extension code for a first application 102 (e.g., the operating system shell 102a shown in FIG. 1G, the browser 102b shown in FIG. 1H, the browser 102c shown in FIG. 1I, the SaaS application 102d shown in FIG. 1J, or the native application 102e shown in FIG. 1J) to be customized for the first user based at least in part on the configuration data (e.g., the microapp correlation data 110). As indicated, the extension code of the first application 102 may be configured to enable the first application 102 to present a user interface for a second application (e.g., a microapp of the microapp service 528) in response to a user input to the first application 102.

As discussed above in connection with FIG. 1G, where the first application 102 is an operating system shell 102a of a client device 202, the resource feed service 518 may, for example, cause extension code of the operating system shell 102a to be customized for the user 524 by instructing the resource access application 522 to register one or more extension handlers with the operating system 142 of the client device 202.

As discussed above in connection with FIG. 1H, where the first application 102 is a browser 102b associated with a resource access application 522, the resource feed service 518 may, for example, cause extension code of the browser 102b to be customized for the user 524 by customizing extension code that is provided to the browser 102b (e.g., via an enterprise extension store 146) and/or by providing extension customization data to the resource access application 522, which extension customization data can then be accessed and used by the browser 102b to customize an extension of the browser 102b.

As discussed above in connection with FIG. 1I, where the first application 102 is a browser 102c that is separate from a resource access application 522, the resource feed service 518 may, for example, cause extension code of the browser 102c to be customized for the user 524 by causing non-customized extension code of the browser 102c (e.g., retrieved from an extension store 152) to be enhanced by providing to the browser 102c (e.g., via the resource access application 522) customized extension code and/or extension customization data that is used to enhance the non-customized extension code.

As discussed above in connection with FIG. 1J, where the first application 102 is a SaaS application 102d accessed via a browser 158 of a client device 202, the resource feed service 518 may, for example, cause extension code of the SaaS application 102d to be customized for the user 524 by selectively installing and/or configuring one or more extensions/add-ins of the SaaS application 102d for a particular user, e.g., via one or more API commands received from the resource feed service 518.

As discussed above in connection with FIG. 1K, where the first application 102 is a native application 102e of a client device 202, the resource feed service 518 may, for example, cause extension code of the native application 102e to be customized for the user 524 by instructing the resource access application 522 to selectively install and/or configure one or more extensions/add-ins of the native application 102e for a particular user, e.g., via one or more API commands.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of an organization.

### C. Computing Environment

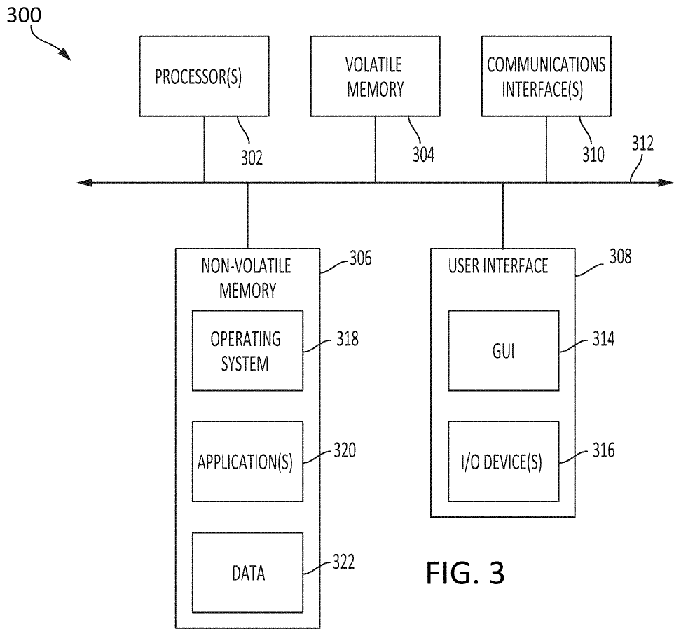

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

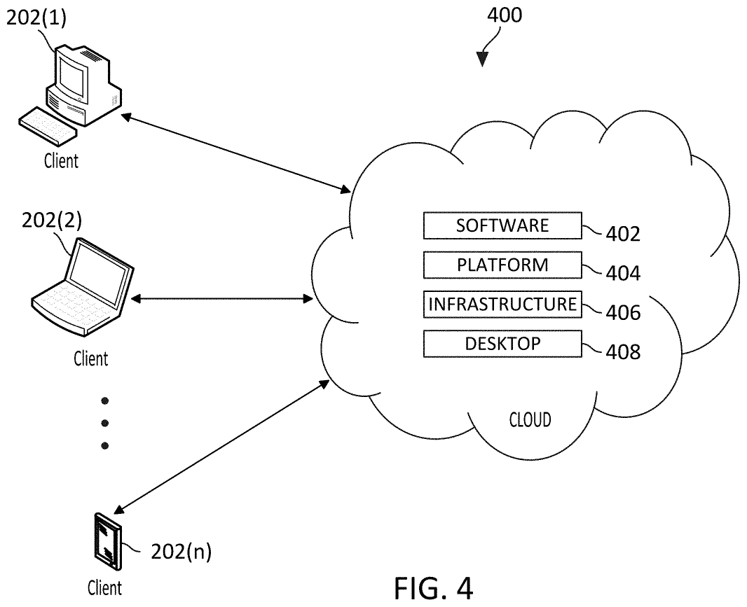

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Wash., Azure IaaS provided by Microsoft Corporation or Redmond, Wash., RACKSPACE CLOUD provided by Rackspace US, Inc., of San Antonio, Tex., Google Compute Engine provided by Google Inc. of Mountain View, Calif., and RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile® from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., ShareFile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource access application 522 is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and XML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system of record to which the notification 546 corresponds, thus helping the user understand the proper context with which to decide how best to respond to the notification 546. In some implementations, one or more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D), a “relevancy” mode (not illustrated) may be selected (e.g., using the element 570) in which the notifications may be sorted based on relevancy scores assigned to them by the analytics service 536, and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp.

In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of available microapp actions. In some implementations, the various microapp actions available to the user 524 logged onto the multi-resource access system 500 may be enumerated to the resource access application 522, e.g., when the user 524 initially accesses the system 500, and the list 554 may include a subset of those available microapp actions. The available microapp actions may, for example, be organized alphabetically based on the names assigned to the actions, and the list 554 may simply include the first several (e.g., the first four) microapp actions in the alphabetical order. In other implementations, the list 554 may alternatively include a subset of the available microapp actions that were most recently or most commonly accessed by the user 524, or that are preassigned by a system administrator or based on some other criteria. The user 524 may also access a complete set of available microapp actions, in a similar manner as the “action” user interface element 552, by clicking on the “view all actions” user interface element 574.

As shown, additional resources may also be accessed through the screen 540 by clicking on or otherwise selecting one or more other user interface elements that may be presented on the screen. For example, in some embodiments, the user may also access files (e.g., via a Citrix ShareFile® platform) by selecting a desired file, e.g., via a drop-down menu accessible using the “files” user interface element 556 or by selecting a desired file from a list 558 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 572 to reveal a list of accessible applications or by selecting a desired application from a list (not shown in FIG. 5D but similar to the list 558) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 574 to reveal a list of accessible desktops or by or by selecting a desired desktop from a list (not shown in FIG. 5D but similar to the list 558) of recently and/or commonly used desktops.

The activity feed shown in FIG. 5D provides significant benefits, as it allows a user to respond to application-specific events generated by disparate systems of record without needing to navigate to, launch, and interface with multiple different native applications.

### F. Detailed Description of Example Embodiments of a System for Customizing an Application Extension to Enable Use of Microapps

Section A introduced various systems and techniques for enabling the customization of one or more application extensions for enabling access to microapp UI controls for a particular user (or group of users) based on configuration data associated with that user/group. For instance, as Section A explains in connection with FIG. 1A, in some implementations, microapp correlation data 110 may be used to customize extension code for a first application 102 to specify (A) the types of microapp actions for which UI controls are to be made available, (B), the contextual circumstances in which such microapp UI controls are to be presented in response to triggering actions, (C) one or more particular actions (e.g., a right-click, a shortcut key, etc.) that are to trigger the presentation of such microapp UI controls under the indicated circumstances, and/or (D) one or more actions that are to be taken using a result that is returned from a system of record 526 in response to the invoked microapp taking the indicated action with respect to that system of record 526.

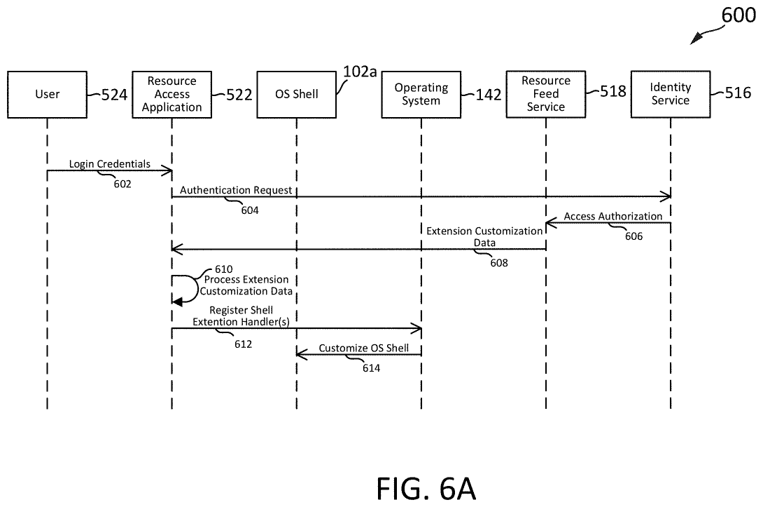

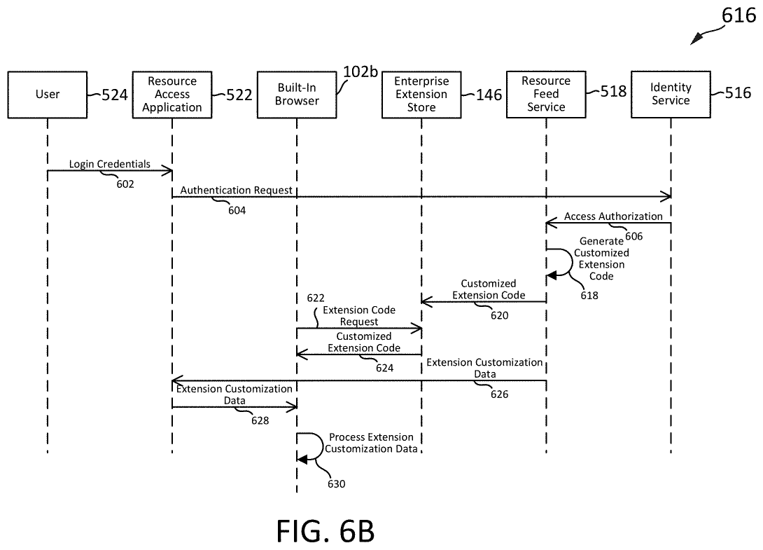

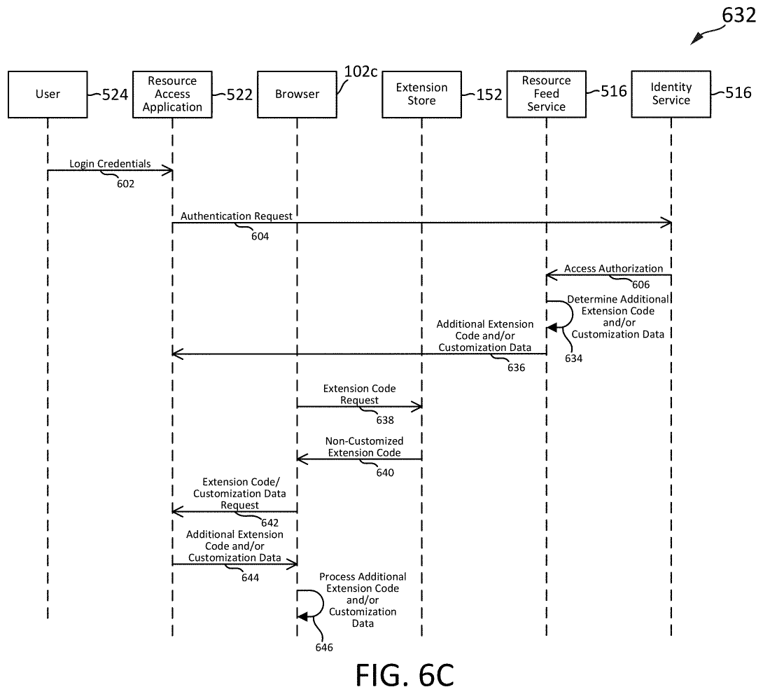

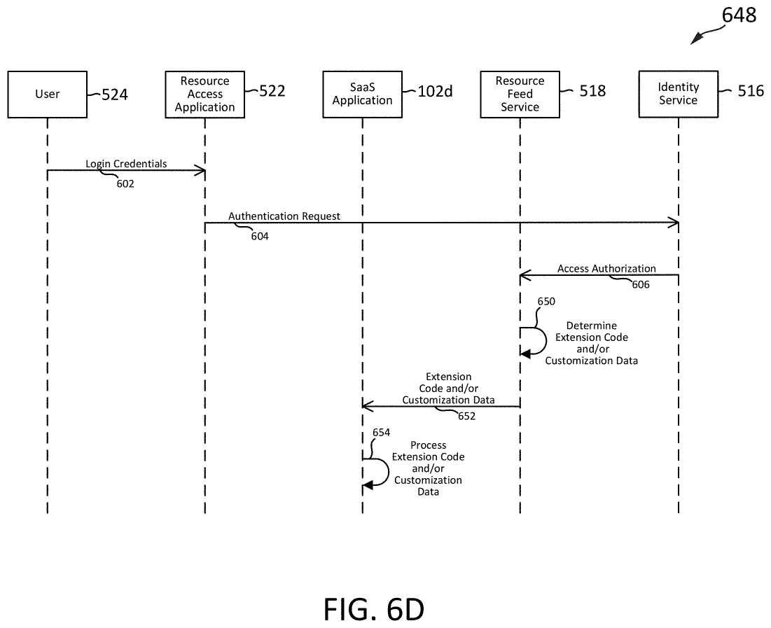

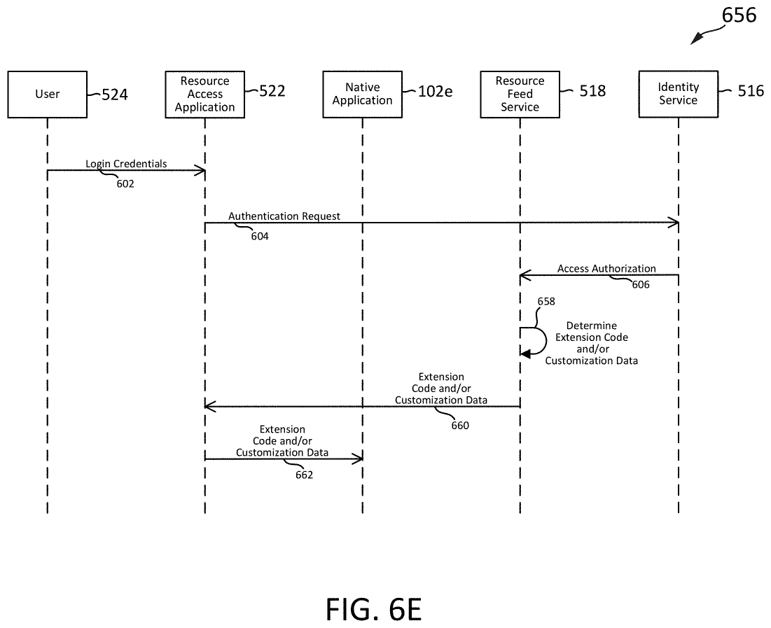

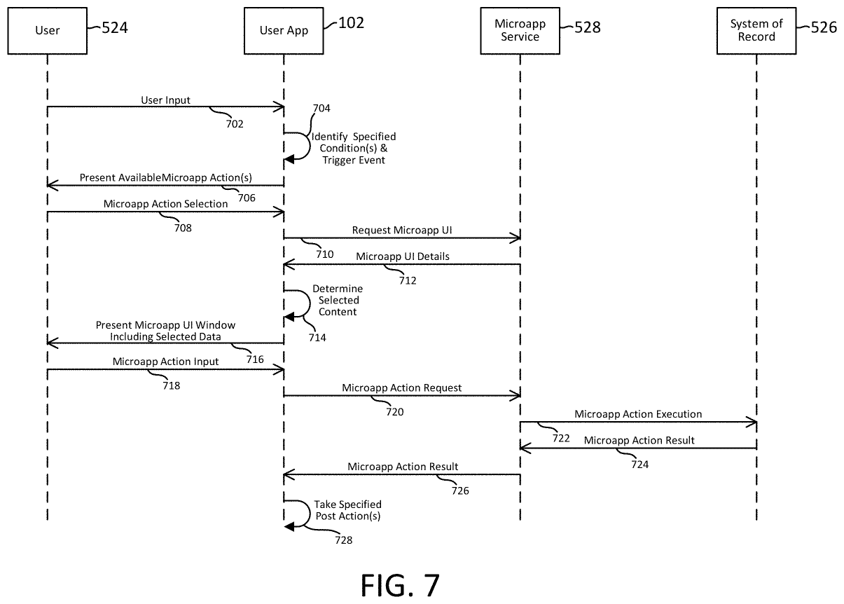

As was discussed in connection with FIGS. 1G-K, the user app 102 may be any of a number of applications, such as (1) an operating system shell 102a (e.g., see FIG. 1G), (2) a web browser 102b embedded in the resource access application 522 (e.g., see FIG. 1H), (3) a web browser 102c separate from the resource access application 522 (e.g., see FIG. 1I), (4) a SaaS application 102d (e.g., see FIG. 1J), (5) a native application 102e (e.g., see FIG. 1H), etc. FIGS. 6A-E are sequence diagrams illustrating example techniques that may be used to customize extensions for those respective types of applications in the context of the multi-resource access system 500 described in Section E. FIG. 7 is a sequence diagram illustrating how a customized extension of a user app 102, no matter its type, may enable microapp actions to be selected and invoked directly from a user interface of the user app 102, and may also enable the user app 102 to receive and process data returned from systems of record 526 as a result of such microapp actions.

FIG. 6A is a sequence diagram 600 illustrating example messages that may be exchanged amongst various components of the multi-resources access system 500 (shown in FIGS. 5A-C), as well as the operating system 142 (shown in FIG. 1G), to customize an extension of an operating system shell 102a (also shown in FIG. 1G) to interact with microapps in accordance with some embodiments of the present disclosure. The sequence diagram 600 thus corresponds to the example configuration 100a of the system 100 introduced above in connection with FIG. 1G.

As shown in FIG. 6A, a user 524 may input (602) login credentials (e.g., a user name and password) to the resource assess application 522. After receiving the user's login credentials, the resource access application 522 may communicate (604) an authentication request to the identity service 516 (described in connection with FIG. 5B). Upon determining the logon credentials are valid, the identity service 516 may, among other things, notify (606) the resource feed service 518 (described in connection with FIG. 5B) that the user 524 is authorized to use the multi-resource access system 500. As described in connection with FIG. 5B, upon receiving the access authorization notification from the identity service 516, the resource feed service 518 may aggregate information concerning the various systems of record 526 the user is authorized to access, and may send information identifying those accessible resources to the resource access application 522 (e.g., via the client interface service 514 shown in FIG. 5B), thus enabling the resource access application 522 to present a list of available resources on a user interface of the client device 202 (e.g., as described in connection with FIG. 5D). As shown, in some implementations, the resource feed service 518 may also send (608) extension customization data (e.g., as indicated by the arrow 138 in FIG. 1G) to the resource access application 522, together with the information identifying the resources that are to be made accessible via the resource access application 522.

The resource access application 522 may process (610) the received customization data to configure one or more appropriate extension handlers, and may register (612) such shell extension handler(s) with the operating system 142. Suitable shell extension handlers are described, for example, at the path “en-us/windows/win32/shellhandlers” of the uniform resource locator (URL) “docs.microsoft.com.” As noted in Section A, the extension customization data (indicated by the arrow 138 in FIG. 1G) may, for example, include one or more component object model (COM) objects embodying the extension handlers that the resources access application 522 is to register with the operating system 142. In some implementations, such COM objects may be configured by the resource feed service 518 based on the microapp correlation data 110 described above in connection with FIG. 1A. Additionally or alternatively, the extension customization data that the resources feed service 518 provides to the resource access application 522 may include some or all of the microapp correlation data 110 associated with the user 524. In some such implementations, such microapp correlation data 110 may be used by the resource access application 522 to configure one or more COM objects so as to customize extension handler(s) for the user 524 prior to registering such extension handler(s) with the operating system 142.

Once the resource access application 522 has registered the customized shell extension handler(s) with the operating system 142, the operating system 142 may enable (614) use of the custom features of the operating system shell 102a. The user 524 may thereafter interact with the operating system shell 102a to access one or more user interface features for microapps, such as user interface menu 130 and user interface window 132 described above in connection with FIGS. 1D-F. The sequence diagram 700 (described below in connection with FIG. 7) shows example interactions that may occur amongst the user 524, the resource access application 522, the user app 102 (in this case the operating system shell 102a), the microapp service 528, and a system of record 526. Example use cases specific to a customized extension for an operating system shell 102a are described above in connection with FIG. 1G.

FIG. 6B is a sequence diagram 616 illustrating example messages that may be exchanged amongst various components of the multi-resources access system 500 (shown in FIGS. 5A-C), as well as the enterprise extension store 146 (shown in FIG. 1H), to customize an extension of browser 102b that is embedded within or otherwise accessible to the resource access application 522 to interact with microapps in accordance with some embodiments of the present disclosure. As noted above, in some implementations, the enterprise extension store 146 may be included amongst the resource management services 502 shown in FIGS. 5B and 5C. The sequence diagram 616 thus corresponds to the example configuration 100b of the system 100 introduced above in connection with FIG. 1H.

As described above, the browser 102b may, for example, be the specialized browser described in Section E. As Section E describes, the specialized browser may be embedded within the resource access application 522 (as illustrated in FIG. 1H), or may be delivered to the resource access application 522 by one of the resource feeds 504 shown in FIG. 5B, e.g., via a secure browser service.

As shown in FIG. 6B, a user 524 may input (602) login credentials (e.g., a user name and password) to the resource assess application 522. After receiving the user's login credentials, the resource access application 522 may communicate (604) an authentication request to the identity service 516 (described in connection with FIG. 5B). Upon determining the logon credentials are valid, the identity service 516 may, among other things, notify (606) the resource feed service 518 (described in connection with FIG. 5B) that the user 524 is authorized to use the multi-resource access system 500. As described in connection with FIG. 5B, upon receiving the access authorization notification from the identity service 516, the resource feed service 518 may aggregate information concerning the various systems of record 526 the user is authorized to access, and may send information identifying those accessible resources to the resource access application 522 (e.g., via the client interface service 514 shown in FIG. 5B), thus enabling the resource access application 522 to present a list of available resources on a user interface of the client device 202 (e.g., as described in connection with FIG. 5D).

As shown, in some implementations, in addition to providing such resource enumeration services, the resource feed service 518 may generate (618) customized extension code, and may send (620) that customized extension code to an enterprise extension store 146 that is accessible to the browser 102b. Thereafter, the browser 102b may send (622) a request for that customized extension code to the enterprise extension store 146, and the enterprise extension store 146 may send (624) the customized extension code to the browser 102b in response to that request. As described above, in some implementations, the resource feed service 518 may customize the extension code for respective users (or a group of users) based on the microapp correlation data 110 (described above in connection with FIG. 1A) associated with such users (or groups of users) such that the extension code the browser 102b retrieves from the enterprise extension store 146 is customized for the user 524 operating the browser 102b.

As FIG. 6B further illustrates, in some implementations, the resource feed service 518 may additionally or alternatively send (626) extension customization data to the resource access application 522, and the resource access application 522 may make that extension customization data available (628) to the browser 102b. Such extension customization data may, for example, include some or all of the microapp correlation data 110 associated with the user 524. In some implementations, the browser 102b may process (630) such extension customization data to customize, or further customize, the extension code that the browser 102b retrieves from the enterprise extension store 146.

Once the extension for the browser 102b has been customized as outlined above, the user 524 may interact with the browser 102b to access one or more user interface features for microapps, such as user interface menu 130 and user interface window 132 described above in connection with FIGS. 1D-F. The sequence diagram 700 (described below in connection with FIG. 7) shows example interactions that may occur amongst the user 524, the resource access application 522, the user app 102 (in this case the embedded browser 102b), the microapp service 528, and a system of record 526. Example use cases specific to a customized extension for an embedded browser 102b are described above in connection with FIG. 1H.

FIG. 6C is a sequence diagram 632 illustrating example messages that may be exchanged amongst various components of the multi-resources access system 500 (shown in FIGS. 5A-C), as well as the extension store 152 (shown in FIG. 1I), to customize an extension of a standard browser 102c (which is separate from the resource access application 522) to interact with microapps in accordance with some embodiments of the present disclosure. The extension store 152 may, for example, be the Internet Explorer Gallery, the Chrome Web Store, the Firefox Browser Add-Ons website, etc. The sequence diagram 632 thus corresponds to the example configuration 100c of the system 100 introduced above in connection with FIG. 1I.

As shown in FIG. 6C, a user 524 may input (602) login credentials (e.g., a user name and password) to the resource assess application 522. After receiving the user's login credentials, the resource access application 522 may communicate (604) an authentication request to the identity service 516 (described in connection with FIG. 5B). Upon determining the logon credentials are valid, the identity service 516 may, among other things, notify (606) the resource feed service 518 (described in connection with FIG. 5B) that the user 524 is authorized to use the multi-resource access system 500. As described in connection with FIG. 5B, upon receiving the access authorization notification from the identity service 516, the resource feed service 518 may aggregate information concerning the various systems of record 526 the user is authorized to access, and may send information identifying those accessible resources to the resource access application 522 (e.g., via the client interface service 514 shown in FIG. 5B), thus enabling the resource access application 522 to present a list of available resources on a user interface of the client device 202 (e.g., as described in connection with FIG. 5D).

In some implementations, in addition to providing such resource enumeration services, the resource feed service 518 may generate or otherwise determine (634) customized extension code and/or customization data, and may send (636) that information to the resource access application 522, for subsequent use by the browser 102c, as described in more detail below.

As shown in FIG. 6C, the browser 102c may request (638) code for a non-customized extension from the extension store 152, and the extension store 152 may send (640) code for the non-customized extension to the browser 102c. In some implementations, an administrator of the system 100 may, for example, publish the non-customized extension on the extension store 152, and the user 524 of the client device 202 may operate the browser 102c to visit the extension store 152 and download/install the code for the non-customized extension.

Once it installed, the non-customized extension of the browser 102c may request (642) the additional extension code and/or customization data from the resource access application 522, and the resource access application 522 may send (644) the additional extension code and/or customization data to the browser 102c. As indicated, the browser 102c may then process (646) that additional extension code and/or customization data to implement an extension that is customized for the user 524, e.g., based on the microapp correlation data 110 described in connection with FIG. 1A. In some implementations, the resource feed service 518 may generate customized extension code for respective users (or a group of users) based on the microapp correlation data 110 (described above in connection with FIG. 1A) associated with such users (or groups of users) such that the extension code that the resource feed service 518 sends to the resource access application 522, and that the browser 102c retrieves from the resource access application 522 (per the arrow 156 in FIG. 1I), is customized for the user 524 operating the browser 102c.

Further, in some implementations, the resource feed service 518 may additionally or alternatively provide extension customization data to the resource access application 522. Such extension customization data may, for example, include some or all of the microapp correlation data 110 associated with the user 524. In some implementations, the browser 102c may use such extension customization data to customize the non-customized extension (retrieved per the arrow 151 in FIG. 1I) and/or to customize, or further customize, the extension code that the browser 102c receives from the resource access application 522 (per the arrow 156 in FIG. 1I).

Once the extension for the browser 102c has been customized as outlined above, the user 524 may interact with the browser 102c to access one or more user interface features for microapps, such as user interface menu 130 and user interface window 132 described above in connection with FIGS. 1D-F. The sequence diagram 700 (described below in connection with FIG. 7) shows example interactions that may occur amongst the user 524, the resource access application 522, the user app 102 (in this case the standard browser 102c), the microapp service 528, and a system of record 526. Example use cases specific to a customized extension for a standard browser 102c are described above in connection with FIG. 1I.

FIG. 6D is a sequence diagram 648 illustrating example messages that may be exchanged amongst various components of the multi-resources access system 500 (shown in FIGS. 5A-C) to customize an extension of a SaaS application 102d to interact with microapps in accordance with some embodiments of the present disclosure. The sequence diagram 648 thus corresponds to the example configuration 100d of the system 100 introduced above in connection with FIG. 1J.

As shown in FIG. 6D, a user 524 may input (602) login credentials (e.g., a user name and password) to the resource assess application 522. After receiving the user's login credentials, the resource access application 522 may communicate (604) an authentication request to the identity service 516 (described in connection with FIG. 5B). Upon determining the logon credentials are valid, the identity service 516 may, among other things, notify (606) the resource feed service 518 (described in connection with FIG. 5B) that the user 524 is authorized to use the multi-resource access system 500. As described in connection with FIG. 5B, upon receiving the access authorization notification from the identity service 516, the resource feed service 518 may aggregate information concerning the various systems of record 526 the user is authorized to access, and may send information identifying those accessible resources to the resource access application 522 (e.g., via the client interface service 514 shown in FIG. 5B), thus enabling the resource access application 522 to present a list of available resources on a user interface of the client device 202 (e.g., as described in connection with FIG. 5D).

In some implementations, in addition to providing such resource enumeration services, the resource feed service 518 may generate or otherwise determine (650) customized extension code and/or customization data, and may send (652) that information to the SaaS application 102d together with instructions to use that code/data to customize one or more extensions of the SaaS application 102d. The SaaS application 102d may be configured such that one or more extensions of the SaaS application 102d may be selectively installed and/or configured (654) for a particular user, e.g., via one or more API commands sent to the SaaS application 102 together with the customized extension code and/or customization data. As one example, the SaaS application may be a Microsoft Office 365 application and an administrator of the system 100 may enable the resource feed service 518 to install and/or configure one or more extensions/add-ins of the SaaS application 102d.

In some implementations, the resource feed service 518 may generate customized extension code for respective users (or a group of users) based on the microapp correlation data 110 (described above in connection with FIG. 1A) associated with such users (or groups of users) such that the extension code that the resource feed service 518 provides to the SaaS application 102d is customized for the user 524 operating the browser 158.

Further, in some implementations, the resource feed service 518 may additionally or alternatively provide extension customization data to the SaaS application 102d. Such extension customization data may, for example, include some or all of the microapp correlation data 110 associated with the user 524. In some implementations, the SaaS application 102d may use such extension customization data to customize a non-customized extension of the SaaS application 102d and/or to customize, or further customize, the extension code that the resource feed service 518 provides to the SaaS application 102d (per the arrow 160 in FIG. 1J).

Once the extension for the SaaS application 102d has been customized as outlined above, the user 524 may interact with the SaaS application 102d to access one or more user interface features for microapps, such as user interface menu 130 and user interface window 132 described above in connection with FIGS. 1D-F. As noted above, the SaaS application 102d may be accessed using a browser 158 (shown in FIG. 1J), which may be either embedded within a resource access application 522 (like the browser 102b described in connection with FIG. 1H) or may be separate from the resource access application 522 (like the browser 102c described in connection with FIG. 1I). The sequence diagram 700 (described below in connection with FIG. 7) shows example interactions that may occur amongst the user 524, the resource access application 522, the user app 102 (in this case the SaaS application 102d accessed via a browser 158), the microapp service 528, and a system of record 526. Example use cases specific to a customized extension for a SaaS application 102d are described above in connection with FIG. 1J.

FIG. 6E is a sequence diagram 656 illustrating example messages that may be exchanged amongst various components of the multi-resources access system 500 (shown in FIGS. 5A-C) to customize an extension of a native application 102e to interact with microapps in accordance with some embodiments of the present disclosure. The sequence diagram 656 thus corresponds to the example configuration 100e of the system 100 introduced above in connection with FIG. 1K.

As shown in FIG. 6E, a user 524 may input (602) login credentials (e.g., a user name and password) to the resource assess application 522. After receiving the user's login credentials, the resource access application 522 may communicate (604) an authentication request to the identity service 516 (described in connection with FIG. 5B). Upon determining the logon credentials are valid, the identity service 516 may, among other things, notify (606) the resource feed service 518 (described in connection with FIG. 5B) that the user 524 is authorized to use the multi-resource access system 500. As described in connection with FIG. 5B, upon receiving the access authorization notification from the identity service 516, the resource feed service 518 may aggregate information concerning the various systems of record 526 the user is authorized to access, and may send information identifying those accessible resources to the resource access application 522 (e.g., via the client interface service 514 shown in FIG. 5B), thus enabling the resource access application 522 to present a list of available resources on a user interface of the client device 202 (e.g., as described in connection with FIG. 5D).

In some implementations, in addition to providing such resource enumeration services, the resource feed service 518 may generate or otherwise determine (658) customized extension code and/or customization data, and may send (660) that information to the resource access application 522. The resource access application 522 may then instruct (662) the native application 102e to install and/or configure an extension of the native application 102e, e.g., via one or API commands. In some implementations, the resource feed service 518 may generate customized extension code for respective users (or a group of users) based on the microapp correlation data 110 (described above in connection with FIG. 1A) associated with such users (or groups of users) such that the extension code that the resource feed service 518 provides to the resource access application 522 is customized for the user 524 operating the native application 102e.

Further, in some implementations, the resources feed service 518 may additionally or alternatively provide extension customization data to the native application 102e (via the resource access application 522—per the arrows 162 and 164 in FIG. 1K). Such extension customization data may, for example, include some or all of the microapp correlation data 110 associated with the user 524. In some implementations, the native application 102e may use such extension customization data to customize a non-customized extension of the native application 102e and/or to customize, or further customize, the extension code that the resource feed service 518 provides to the native application 102e (via the resource access application 522—per the arrows 162 and 164 in FIG. 1K). As one example, the native application 102e may be a Microsoft Outlook application installed on the client device 202 together with the resource access application 522, and the user 524 of the client device 202 may enable the resource access application 522 to install and/or configure one or more extensions/add-ins of the native application 102e.

Once the extension for the native application 102e has been customized as outlined above, the user 524 may interact with the native application 102e to access one or more user interface features for microapps, such as user interface menu 130 and user interface window 132 described above in connection with FIGS. 1D-F. The sequence diagram 700 (described below in connection with FIG. 7) shows example interactions that may occur amongst the user 524, the resource access application 522, the user app 102 (in this case the native application 102e), the microapp service 528, and a system of record 526. Example use cases specific to a customized extension for a native application 102e are described above in connection with FIG. 1K.

As noted on several occasions above, FIG. 7 is a sequence diagram 700 illustrating example interactions that may occur amongst the user 524, the resource access application 522, the user app 102 (which may be any of the user apps 102a-e described above), the microapp service 528, and a system of record 526. As shown, once the extension for the user app 102 has been customized (e.g., as described above in connection with FIGS. 6A-E) and launched (e.g., using any of the techniques described above in connection with FIG. 5B), the user 524 may interact (702) with the user app 102 in various way to invoke microapp functionality as described herein. Among other things, the user may select content within a user interface of the user app 102 (e.g., within the window 124 for User App A described above in connection with FIGS. 1B-F). As one example, the user 524 may select a text string by moving the cursor 128 while clicking and holding a left mouse button, e.g., as described above in connection with FIG. 1C. As another example, the user 524 may select an icon or other identifier of a file, e.g., within an operating system shell, by using a mouse to hover over or click on such an icon/identifier.

As shown in FIG. 7, the user app 102 (via the customized extension) may identify (704) occasions on which a trigger event specified in the microapp correlation data 110, e.g., per “trigger” entries 116, occurs at the same time that a corresponding condition specified in the microapp correlation data 110, e.g., per “condition” entries 114, is satisfied. For example, the user 524, while interacting with a user interface for the user app 102 (e.g., the window 124 for User App A described above in connection with FIGS. 1B-F), may have right-clicked on a mouse, or provided another input, while a portion of the content 126 is selected (e.g., as shown in FIG. 1C) and/or while the user app 102 is in some other particular state indicated by a condition entry 114 associated with the detected trigger condition in the microapp correlation data 110.

If, at the step 704, the user app 102 determines (via the customized extension) that a trigger event (e.g., a right mouse click) corresponding to one or more satisfied conditions has occurred, the user app 102 may cause the client device 202 to present (706) a user interface feature, e.g., the user interface menu 130 shown in FIG. 1D, identifying one or more microapp actions that are available for use. In some implementations, the user app 102 may include within the user interface feature that is so presented, e.g., the user interface menu 130, selectable user interface elements for respective ones of the actions names identified in the microapp correlation data 110, e.g., per “action name” entries 118, for which both (A) the corresponding condition, e.g., per a “condition” entry 114, is satisfied, and (B) the corresponding trigger event, e.g., per a “trigger” entry 116, has occurred.

Referring still to FIG. 7, the user 524 may provide (708) an input to the user app 102 indicating a selection of one of the microapp actions identified in the user interface feature presented per the step 706, e.g., by selecting “Action B” within the user interface menu 130, as shown in FIG. 1E.

Upon receiving an input selecting a microapp action, the user app 102 (via the customized extension) may send (710) to the microapp service 528 a request for content and UI controls for a user interface window for the selected microapp action, e.g., the user interface window 132 shown in FIG. 1F. As shown, in response to the request, the microapp service 528 may return (712) the requested content and UI controls for the user interface window. As noted above, in some implementations, the “action ID” entry 120 corresponding to the selected action name in the microapp correlation data 110, may be used by the customized extension code to identify and/or retrieve the content and UI controls for the user interface window 132 from the microapp service 528. In other implementations, the “action ID” entries 120 may themselves include the content and UI controls, or point to locally stored content and UI controls, for user interface window 132 for particular microapp actions. In such implementations, the steps 710 and 712 shown in FIG. 7 would not be required.

In response to receiving the content and UI controls for the user interface window (per the step 712), the user app 102 (via the customized extension) may determine (714) content that may have been selected within the user interface of the user app 102, e.g., within the window 124 of User App A, as shown in FIGS. 1B and 1C, at the time the user provided the trigger input, e.g., as illustrated in FIG. 1D.

After determining the content, if any, that had been selected when the trigger input was provided, the user app 102 (via the customized extension) may present (716) a user interface window, e.g., the user interface window 132 shown in FIG. 1F, for the selected microapp action. As indicated, when the user app 102 has determined content that was selected within the user interface for the user app 102 (e.g., per the step 714, as discussed above), the user app 102 (via the customized extension) may insert that content into an appropriate location within the user interface window. In the circumstance shown in FIG. 1F, for example, the user app 102 may have inserted the selected content “Text B” into the Tillable field 134 within the user interface window 132.

Upon receiving (718) an input from the user 524 indicating that the selected microapp action is to be taken, e.g., in response to the user 524 selecting the user interface element 136 within the user interface window 132 shown in FIG. 1F, the user app 102 (via the customized extension) may send (720) a message to the microapp service 528 requesting that the indicated action be taken with respect to the system of record 526. In some implementations, the user 524 may be permitted to modify the content that was inserted into the user interface window for the selected microapp action prior to providing the input (per the steps 714 and 716) indicating that the selected microapp action is to be taken.

Upon receiving the “action request” message from the user app 102 (per the step 720), the microapp service 528 may take (722) the requested action with the system of record 526 on behalf of the user 524, e.g., by retrieving access credentials for the user 524 and making one or more API calls to the system of record 526 using those credentials. In some circumstances, some or all of the content that was inserted into the user interface for the microapp action (per the steps 7) may be used take the action with respect to the system of record 526.

Upon completing the requested action, the system of record 526 may send (724) a message to the microapp service 528 that is indicative of a result of taking the requested action. For instance, upon completing the action, the system of record 526 may have generated a link or other information indicative of data that was stored or is otherwise available as a result of completing the action. The message sent (724) to the microapp service 528 may include that link or other information corresponding to the determined result.

Upon receiving such a result from the system of record 526, the microapp service 528 may send (726) a message indicative of the result to the user app 102. Upon receiving the result data from the microapp service 528, the user app 102 (via the customized extension) may take (728) the action(s) indicated by the microapp correlation data 110, e.g., by one or more “post action(s)” entries 122, such as process the result data in a particular way and/or presenting the result within the user interface window for the user app 102, e.g., the window 124 of User App A shown in FIGS. 1B-F.

### G. Example Implementations of Methods, Systems, and Computer-Readable Media in Accordance with the Present Disclosure

The following paragraphs (M1) through (M15) describe examples of methods that may be implemented in accordance with the present disclosure.

(M1) A method may be performed that involves determining that configuration data is associated with a first user; and causing, based at least in part on the configuration data being associated with the first user, extension code for a first application to be customized for the first user based at least in part on the configuration data, wherein the extension code is configured to enable the first application to present a user interface for a second application in response to a user input to the first application.

(M2) A method may be performed as described in paragraph (M1), wherein the first application may be configured to be executed under control of a client device, and causing the extension code to be customized for the first user may be further based at least in part on a determination that the first user is operating the client device.

(M3) A method may be performed as described in paragraph (M2), wherein causing the extension code to be customized for the first user may further involve sending, from a computing system to a resource access application executing under control of the client device, the extension code and at least one instruction that causes the resource access application to cause the extension code to be added to the first application.

(M4) A method may be performed as described in paragraph (M3), wherein the first application may comprise a shell of an operating system; and the at least one instruction may cause the resource access application to register at least one shell extension handler with the operating system.

(M5) A method may be performed as described in any of paragraphs (M1) through (M4), wherein causing the extension code to be customized for the first user may further involve causing the extension code to be added to the first application.

(M6) A method may be performed as described in any of paragraphs (M1) through (M5), wherein causing the extension code to be customized for the first user may further involve generating the extension code based at least in part on the configuration data.

(M7) A method may be performed as described in paragraph (M6), wherein generating the extension code may further involve including at least a portion of the configuration data in the extension code.

(M8) A method may be performed as described in any of paragraphs (M1) through (M7), wherein the first application may comprise a browser, and causing the extension code to be customized for the first user may further involve using the configuration data to customize an extension of the browser for the first user.

(M9) A method may be performed as described in paragraph (M8), and may further involve receiving, from the browser, a request for data indicative of a customized extension for the browser; and in response to the request, sending, to the browser, the data indicative of the customized extension.

(M10) A method may be performed as described in paragraph (M9), wherein the browser may be executing under control of a client device, and the method may further involve receiving, by a resource access application executing under control of the client device, the request from the browser; and sending, from the resource access application to the browser, the data indicative of the customized extension.

(M11) A method may be performed as described in paragraph (M10), wherein the browser may be executing under control of a client device, and the method may further involve causing the browser to send, to an extension store remote from the client device, a request for data indicative of a customized extension for the browser; and causing the browser to receive and process the data indicative of the customized extension to customize the extension of the browser for the first user.

(M12) A method may be performed as described in any of paragraphs (M1) through (M11), wherein the user interface may include at least one user interface element that is selectable to cause the second application to take a first action with respect to a third application.

(M13) A method may be performed as described in paragraph (M12), wherein the configuration data may be indicative of a second action that is to be taken in response to receiving a result of the first action taken by the second application with respect to the third application.

(M14) A method may be performed as described in any of paragraphs (M1) through (M13), wherein the configuration data may be indicative of a type of the user input that is to enable presentation of the user interface for the second application

(M15) A method may be performed as described in any of paragraphs (M1) through (M14), wherein the configuration data may be indicative of a condition under which presentation of the user interface is to be enabled in response to the user input.

The following paragraphs (S1) through (S15) describe examples of systems and devices that may be implemented in accordance with the present disclosure.

(S1) A system may comprise at least one processor, and at least one computer-readable medium encoded with instructions which, when executed by the at least one processor, cause the system to determine that configuration data is associated with a first user, and to cause, based at least in part on the configuration data being associated with the first user, extension code for a first application to be customized for the first user based at least in part on the configuration data, wherein the extension code is configured to enable the first application to present a user interface for a second application in response to a user input to the first application.

(S2) A system may be configured as described in paragraph (S1), wherein the first application may be configured to be executed under control of a client device, and the at least one computer-readable medium may be further encoded with additional instructions which, when executed by the at least one processor, further cause the system to cause the extension code to be customized for the first user further based at least in part on a determination that the first user is operating the client device.

(S3) A system may be configured as described in paragraph (S2), wherein the at least one computer-readable medium may be further encoded with additional instructions which, when executed by the at least one processor, further cause the system to cause the extension code to be customized for the first user at least in part by sending, from a computing system to a resource access application executing under control of the client device, the extension code and at least one instruction that causes the resource access application to cause the extension code to be added to the first application.

(S4) A system may be configured as described in paragraph (S3), wherein the first application may comprise a shell of an operating system, and the at least one computer-readable medium may be further encoded with additional instructions which, when executed by the at least one processor, further cause the system to configure the at least one instruction to cause the resource access application to register at least one shell extension handler with the operating system.

(S5) A system may be configured as described in any of paragraphs (S1) through (S4), wherein the at least one computer-readable medium may be further encoded with additional instructions which, when executed by the at least one processor, further cause the system to cause the extension code to be customized for the first user at least in part by causing the extension code to be added to the first application.

(S6) A system may be configured as described in any of paragraphs (S1) through (S5), wherein the at least one computer-readable medium may be further encoded with additional instructions which, when executed by the at least one processor, further cause the system to cause the extension code to be customized for the first user at least in part by generating the extension code based at least in part on the configuration data.

(S7) A system may be configured as described in paragraph (S6), wherein the at least one computer-readable medium may be further encoded with additional instructions which, when executed by the at least one processor, further cause the system to generate the extension code at least in part by including at least a portion of the configuration data in the extension code.

(S8) A system may be configured as described in any of paragraphs (S1) through (S7), wherein the first application may comprise a browser, and the at least one computer-readable medium may be further encoded with additional instructions which, when executed by the at least one processor, further cause the system to cause the extension code to be customized for the first user at least in part by using the configuration data to customize an extension of the browser for the first user.

(S9) A system may be configured as described in paragraph (S8), wherein the at least one computer-readable medium may be further encoded with additional instructions which, when executed by the at least one processor, further cause the system to receive, from the browser, a request for data indicative of a customized extension for the browser, and to send, to the browser, the data indicative of the customized extension in response to the request.

(S10) A system may be configured as described in paragraph (S9), wherein the browser may be executing under control of a client device, and the at least one computer-readable medium may be further encoded with additional instructions which, when executed by the at least one processor, further cause the system to receive, by a resource access application executing under control of the client device, the request from the browser, and to send, from the resource access application to the browser, the data indicative of the customized extension.

(S11) A system may be configured as described in paragraph (S10), wherein the browser may be executing under control of a client device, and the at least one computer-readable medium may be further encoded with additional instructions which, when executed by the at least one processor, further cause the system to cause the browser to send, to an extension store remote from the client device, a request for data indicative of a customized extension for the browser, and to cause the browser to receive and process the data indicative of the customized extension to customize the extension of the browser for the first user.

(S12) A system may be configured as described in any of paragraphs (S1) through (S11), wherein the user interface may include at least one user interface element that is selectable to cause the second application to take a first action with respect to a third application.

(S13) A system may be configured as described in paragraph (S12), wherein the configuration data may be indicative of a second action that is to be taken in response to receiving a result of the first action taken by the second application with respect to the third application.

(S14) A system may be configured as described in any of paragraphs (S1) through (S13), wherein the configuration data may be indicative of a type of the user input that is to enable presentation of the user interface for the second application

(S15) A system may be configured as described in any of paragraphs (S1) through (S14), wherein the configuration data may be indicative of a condition under which presentation of the user interface is to be enabled in response to the user input.

The following paragraphs (CRM1) through (CRM15) describe examples of computer-readable media that may be implemented in accordance with the present disclosure.

(CRM1) At least one non-transitory, computer-readable medium may be encoded with instructions which, when executed by at least one processor included in a system, cause the system to determine that configuration data is associated with a first user, and to cause, based at least in part on the configuration data being associated with the first user, extension code for a first application to be customized for the first user based at least in part on the configuration data, wherein the extension code is configured to enable the first application to present a user interface for a second application in response to a user input to the first application.

(CRM2) At least one non-transitory, computer-readable medium may be configured as described in paragraph (CRM1), wherein the first application may be configured to be executed under control of a client device, and the at least one computer-readable medium may be further encoded with additional instructions which, when executed by the at least one processor, further cause the system to cause the extension code to be customized for the first user further based at least in part on a determination that the first user is operating the client device.

(CRM3) At least one non-transitory, computer-readable medium may be configured as described in paragraph (CRM2), and may be further encoded with additional instructions which, when executed by the at least one processor, further cause the system to cause the extension code to be customized for the first user at least in part by sending, from a computing system to a resource access application executing under control of the client device, the extension code and at least one instruction that causes the resource access application to cause the extension code to be added to the first application.

(CRM4) At least one non-transitory, computer-readable medium may be configured as described in paragraph (CRM3), wherein the first application may comprise a shell of an operating system, and the at least one computer-readable medium may be further encoded with additional instructions which, when executed by the at least one processor, further cause the system to configure the at least one instruction to cause the resource access application to register at least one shell extension handler with the operating system.

(CRM5) At least one non-transitory, computer-readable medium may be configured as described in any of paragraphs (CRM1) through (CRM4), and may be further encoded with additional instructions which, when executed by the at least one processor, further cause the system to cause the extension code to be customized for the first user at least in part by causing the extension code to be added to the first application.

(CRM6) At least one non-transitory, computer-readable medium may be configured as described in any of paragraphs (CRM1) through (CRM5), and may be further encoded with additional instructions which, when executed by the at least one processor, further cause the system to cause the extension code to be customized for the first user at least in part by generating the extension code based at least in part on the configuration data.

(CRM7) At least one non-transitory, computer-readable medium may be configured as described in paragraph (CRM6), and may be further encoded with additional instructions which, when executed by the at least one processor, further cause the system to generate the extension code at least in part by including at least a portion of the configuration data in the extension code.

(CRM8) At least one non-transitory, computer-readable medium may be configured as described in any of paragraphs (CRM1) through (CRM7), wherein the first application may comprise a browser, and the at least one computer-readable medium may be further encoded with additional instructions which, when executed by the at least one processor, further cause the system to cause the extension code to be customized for the first user at least in part by using the configuration data to customize an extension of the browser for the first user.

(CRM9) At least one non-transitory, computer-readable medium may be configured as described in paragraph (CRM8), and may be further encoded with additional instructions which, when executed by the at least one processor, further cause the system to receive, from the browser, a request for data indicative of a customized extension for the browser, and to send, to the browser, the data indicative of the customized extension in response to the request.

(CRM10) At least one non-transitory, computer-readable medium may be configured as described in paragraph (CRM9), wherein the browser may be executing under control of a client device, and the at least one computer-readable medium may be further encoded with additional instructions which, when executed by the at least one processor, further cause the system to receive, by a resource access application executing under control of the client device, the request from the browser, and to send, from the resource access application to the browser, the data indicative of the customized extension.

(CRM11) At least one non-transitory, computer-readable medium may be configured as described in paragraph (CRM10), wherein the browser may be executing under control of a client device, and the at least one computer-readable medium may be further encoded with additional instructions which, when executed by the at least one processor, further cause the system to cause the browser to send, to an extension store remote from the client device, a request for data indicative of a customized extension for the browser, and to cause the browser to receive and process the data indicative of the customized extension to customize the extension of the browser for the first user.

(CRM12) At least one non-transitory, computer-readable medium may be configured as described in any of paragraphs (CRM1) through (CRM11), wherein the user interface may include at least one user interface element that is selectable to cause the second application to take a first action with respect to a third application.

(CRM13) At least one non-transitory, computer-readable medium may be configured as described in paragraph (CRM12), wherein the configuration data may be indicative of a second action that is to be taken in response to receiving a result of the first action taken by the second application with respect to the third application.

(CRM14) At least one non-transitory, computer-readable medium may be configured as described in any of paragraphs (CRM1) through (CRM13), wherein the configuration data may be indicative of a type of the user input that is to enable presentation of the user interface for the second application

(CRM15) At least one non-transitory, computer-readable medium may be configured as described in any of paragraphs (CRM1) through (CRM14), wherein the configuration data may be indicative of a condition under which presentation of the user interface is to be enabled in response to the user input.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
determining that configuration data is associated with a first user; and
causing, based at least in part on the configuration data being associated with the first user, extension code for a first application to be customized for the first user based at least in part on the configuration data, wherein the extension code is configured to enable the first application to present a user interface for a second application in response to a user input to the first application.

2. The method of claim 1, wherein:
the first application is configured to be executed under control of a client device; and
causing the extension code to be customized for the first user is further based at least in part on a determination that the first user is operating the client device.

3. The method of claim 2, wherein causing the extension code to be customized for the first user further comprises:
sending, from a computing system to a resource access application executing under control of the client device, the extension code and at least one instruction that causes the resource access application to cause the extension code to be added to the first application.

4. The method of claim 3, wherein:
the first application comprises a shell of an operating system; and
the at least one instruction causes the resource access application to register at least one shell extension handler with the operating system.

5. The method of claim 1, wherein causing the extension code to be customized for the first user further comprises:
causing the extension code to be added to the first application.

6. The method of claim 1, wherein causing the extension code to be customized for the first user further comprises:
generating the extension code based at least in part on the configuration data.

7. The method of claim 6, wherein generating the extension code further comprises including at least a portion of the configuration data in the extension code.

8. The method of claim 1, wherein the first application comprises a browser, and causing the extension code to be customized for the first user further comprises:
using the configuration data to customize an extension of the browser for the first user.

9. The method of claim 8, further comprising:
receiving, from the browser, a request for data indicative of a customized extension for the browser; and
in response to the request, sending, to the browser, the data indicative of the customized extension.

10. The method of claim 9, wherein the browser is executing under control of a client device, and the method further comprises:
receiving, by a resource access application executing under control of the client device, the request from the browser; and
sending, from the resource access application to the browser, the data indicative of the customized extension.

11. The method of claim 8, wherein the browser is executing under control of a client device, and the method further comprises:
causing the browser to send, to an extension store remote from the client device, a request for data indicative of a customized extension for the browser; and
causing the browser to receive and process the data indicative of the customized extension to customize the extension of the browser for the first user.

12. The method of claim 1, wherein the user interface includes at least one user interface element that is selectable to cause the second application to take a first action with respect to a third application.

13. The method of claim 12, wherein the configuration data is indicative of a second action that is to be taken in response to receiving a result of the first action taken by the second application with respect to the third application.

14. The method of claim 1, wherein the configuration data is indicative of a type of the user input that is to enable presentation of the user interface for the second application.

15. The method of claim 1, wherein the configuration data is indicative of a condition under which presentation of the user interface is to be enabled in response to the user input.

16. A system, comprising:
at least one processor; and
at least one computer-readable medium encoded with instructions which, when executed by the at least one processor, cause the system to:
determine that configuration data is associated with a first user, and
cause, based at least in part on the configuration data being associated with the first user, extension code for a first application to be customized for the first user based at least in part on the configuration data, wherein the extension code is configured to enable the first application to present a user interface for a second application in response to a user input to the first application.

17. The system of claim 16, wherein the first application is configured to be executed under control of a client device, and the at least one computer-readable medium is further encoded with additional instructions which, when executed by the at least one processor, further cause the system to:
cause the extension code to be customized for the first user further based at least in part on a determination that the first user is operating the client device.

18. The system of claim 16, wherein the configuration data is indicative of a type of the user input that is to enable presentation of the user interface for the second application.

19. The system of claim 16, wherein the configuration data is indicative of a condition under which presentation of the user interface is to be enabled in response to the user input.

20. At least one non-transitory computer-readable medium encoded with instructions which, when executed by at least one processor of a system, cause the system to:
determine that configuration data is associated with a first user; and
cause, based at least in part on the configuration data being associated with the first user, extension code for a first application to be customized for the first user based at least in part on the configuration data, wherein the extension code is configured to enable the first application to present a user interface for a second application in response to a user input to the first application.
